(19) United States
(12) Patent Application Publication
(10) Pub. No.: US 2025/0113216 A1
(43) Pub. Date: Apr. 3, 2025

(54) DYNAMIC RETRIEVAL OF NSAC INFORMATION

(71) Applicant: Telefonaktiebolaget LM Ericsson (publ), Stockholm (SE)

(72) Inventors: George Foti, Dollard des Ormeaux (CA); Peter Hedman, Helsingborg (SE); Ralf Keller, Würselen (DE)

(21) Appl. No.: 18/728,979

(22) PCT Filed: Jan. 13, 2023
(86) PCT No.: PCT/IB2023/050334

§ 371 Date: Jul. 15, 2024

Related U.S. Application Data
(60) Provisional application No. 63/305,927, filed on Feb. 2, 2022.
(60) Provisional application No. 63/300,150, filed on Jan. 17, 2022.

(51) Int. Cl. H04W 24/02; H04W 60/00; H04W 84/04

(52) U.S. Cl. CPC H04W 24/02; H04W 60/00; H04W 84/042

(57) ABSTRACT

Systems and methods are disclosed for dynamic retrieval of Network Slice Admission Control (NSAC) information in a Visited Public Land Mobile Network (VPLMN) of a User Equipment (UE). In one embodiment, a method performed by a network node in a VPLMN of a UE comprises receiving, from the UE, a request comprising information indicating a particular network slice that is subject to NSAC. The method further comprises obtaining subscription data that comprises information that indicates whether VPLMN or Home Public Land Mobile Network (HPLMN) control should be applied for NSAC and sending an update request to a Network Slice Admission Control Function (NSACF) in the VPLMN of the UE, wherein the update request comprises the information that indicates whether VPLMN or HPLMN control should be applied for NSAC.

### RELATED APPLICATIONS

This application claims the benefit of provisional patent application Ser. No. 63/305,927, filed Feb. 2, 2022, and provisional patent application Ser. No. 63/300,150, filed Jan. 17, 2022, the disclosures of which are hereby incorporated herein by reference in their entireties.

### TECHNICAL FIELD

The present disclosure relates to a cellular communications system and, more particularly, Network Slice Admission Control (NSAC) in a cellular communications system.

### BACKGROUND

Third Generation Partnership Project (3GPP) Technical Specification (TS) 23.501 V17.2.0 and TS 23.502 V17.2.1 define, among other things, aspects related to Network Slice Admission Control (NSAC). In particular, for a network slice, the NSAC procedures track the number of User Equipments (UEs) or Protocol Data Unit (PDU) sessions on each network slice and deny access to further UEs once a maximum number of UEs or a maximum number of PDU sessions has been reached for that network slice.

### SUMMARY

Systems and methods are disclosed for dynamic retrieval of Network Slice Admission Control (NSAC) information in a Visited Public Land Mobile Network (VPLMN) of a User Equipment (UE). In one embodiment, a method performed by a network node in a VPLMN of a UE comprises receiving, from the UE, a request comprising information indicating a particular network slice that is subject to NSAC. The method further comprises obtaining subscription data that comprises information that indicates whether VPLMN or Home Public Land Mobile Network (HPLMN) control should be applied for NSAC and sending an update request to a Network Slice Admission Control Function (NSACF) in the VPLMN of the UE, wherein the update request comprises the information that indicates whether VPLMN or HPLMN control should be applied for NSAC. In this manner, admission control in the VPLMN for network slices subject to admission control can be supported without requiring pre-configuration.

In one embodiment, a network node for a VPLMN of a UE comprises processing circuitry configured to cause the network node to receive, from the UE, a request comprising information indicating a particular network slice that is subject to NSAC. The processing circuitry is further configured to cause the network node to obtain subscription data that comprises information that indicates whether VPLMN or HPLMN control should be applied for NSAC and send an update request to a NSACF in the VPLMN of the UE, wherein the update request comprises the information that indicates whether VPLMN or HPLMN control should be applied for NSAC.

In one embodiment, a method performed by a NSACF in a VPLMN of a UE comprises receiving, from a network node in the VPLMN of the UE, an update request, the update request being a request to update a number of registered UEs or a number of Protocol Data Unit (PDU) sessions for a HPLMN mapped network slice. The method further comprises obtaining subscription data indicating whether VPLMN or HPLMN control should be applied for NSAC, obtaining, from the HPLMN, information that indicates a maximum number of registered UEs or PDU session for the HPLMN mapped network slice, and applying the maximum number of registered UEs or PDU sessions for the HPLMN mapped network slice when processing the update request.

In one embodiment, obtaining the subscription data indicating whether VPLMN or HPLMN control should be applied for NSAC comprises obtaining the subscription data from any one of: (a) the network node in the VPLMN of the UE, (b) a User Data Management (UDM) in the HPLMN of the UE, or (c) a network node in the HPLMN of the UE.

In one embodiment, the method further comprises subscribing at the HPLMN to any changes to the information that indicates the maximum number of registered UEs or PDU session for the HPLMN mapped network slice.

In one embodiment, the method further comprises, for any subsequent update requests to add a UE entry exceeding the maximum number of registered UEs or PDU sessions for the HPLMN mapped network slice, obtaining admission control from the HPLMN indicating if the request should be granted or not and upon determining the request is granted storing the UE entry.

In one embodiment, the method further comprises, for any subsequent update requests to add a UE entry exceeding the maximum number of registered UEs or PDU sessions for the HPLMN mapped network slice, rejecting the update request.

In one embodiment, a network node that implements a NSACF for a VPLMN of a UE comprises processing circuitry configured to cause the network node to receive, from a network node in the VPLMN of the UE, an update request where the update request is a request to update a number of registered UEs or a number of PDU sessions for a HPLMN mapped network slice. The processing circuitry is further configured to cause the network node to obtain subscription data indicating whether VPLMN or HPLMN control should be applied for NSAC, obtain from the HPLMN, information that indicates a maximum number of registered UEs or PDU session for the HPLMN mapped network slice, and apply the maximum number of registered UEs or PDU sessions for the HPLMN mapped network slice when processing the update request.

In one embodiment, a method comprises, at a network node in a VPLMN of a UE, receiving, from the UE, a request comprising information that indicates a particular network slice that is subject to NSAC, and sending an update request to a NSACF in the VPLMN of the UE where the update request is a request to update a number of registered UEs or a number of PDU sessions for the HPLMN mapped network slice. The method further comprises, at the NSACF in the VPLMN of the UE, receiving the update request from the network node, obtaining information that indicates a maximum number of registered UEs or PDU sessions for a HPLMN mapped network slice associated to the particular network slice from a network node in the HPLMN of the UE, and applying the maximum number of registered UEs or PDU sessions for the HPLMN mapped network slice to process the update request.

In one embodiment, the method further comprises, at the network node in the VPLMN of the UE, obtaining subscription data for the UE, the subscription data comprising information that indicates whether NSAC is controlled by the VPLMN or controlled by the HPLMN.

In one embodiment, the method further comprises, at the NSACF in the VPLMN of the UE, subscribing to changes in slice selection subscription data comprising changes to the maximum number of registered UEs or PDU sessions for the HPLMN mapped network slice. The method further comprises, at the network node in the HPLMN of the UE, responsive to the subscription, notifying the NSACF in the VPLMN of the UE of a change to the maximum number of registered UEs or PDU sessions for the HPLMN mapped network slice.

In one embodiment, a method performed by a NSACF in a VPLMN of a UE comprises receiving an update request from a network node in the VPLMN the UE, the update request being a request to update a number of registered UEs or a number of PDU sessions for a particular network slice. The method further comprises, obtaining information that indicates a maximum number of registered UEs or PDU sessions for a HPLMN mapped network slice associated to the particular network slice from a network node in the HPLMN of the UE and applying the maximum number of registered UEs or PDU sessions for the HPLMN mapped network slice to process the update request.

In one embodiment, the method further comprises subscribing to changes in slice selection subscription data comprising changes to the maximum number of registered UEs or PDU sessions for the HPLMN mapped network slice and, responsive to the subscribing, receiving a notification of a change to the maximum number of registered UEs or PDU sessions for the HPLMN mapped network slice.

In one embodiment, a network node that implements a NSACF for a VPLMN of a UE comprises processing circuitry configured to cause the network node to receive an update request from a network node in the VPLMN the UE, the update request being a request to update a number of registered UEs or a number of PDU sessions for a particular network slice. The processing circuitry is further configured to cause the network node to obtain information that indicates a maximum number of registered UEs or PDU sessions for a HPLMN mapped network slice associated to the particular network slice from a network node in the HPLMN of the UE and apply the maximum number of registered UEs or PDU sessions for the HPLMN mapped network slice to process the update request.

In one embodiment, a method performed by a network node in a HPLMN of a UE comprises receiving, from a NSACF in a VPLMN of the UE, a subscription to changes in slice selection subscription data comprising changes to a maximum number of registered UEs or PDU sessions for a HPLMN mapped network slice and, responsive to the subscription, sending, to the NSACF in the VPLMN of the UE, a notification of a change to the maximum number of registered UEs or PDU sessions for the HPLMN mapped network slice.

In one embodiment, a network node for a HPLMN of a UE comprises processing circuitry configured to cause the network node to receive, from a NSACF in a VPLMN of the UE, a subscription to changes in slice selection subscription data comprising changes to a maximum number of registered UEs or PDU sessions for a HPLMN mapped network slice and, responsive to the subscription, send, to the NSACF in the VPLMN of the UE, a notification of a change to the maximum number of registered UEs or PDU sessions for the HPLMN mapped network slice.

In one embodiment, a method comprises, at a network node in a VPLMN of a UE, receiving, from the UE, a request comprising information that indicates a particular network slice that is subject to NSAC, obtaining subscription data that comprises information that indicates a maximum number of registered UEs or PDU sessions for a HPLMN mapped network slice associated to the particular network slice indicated by the request received by the network node in the VPLMN, and sending an update request to a NSACF in the VPLMN of the UE, wherein the update request is a request to update a number of registered UEs or a number of PDU sessions for the HPLMN mapped network slice and the update request comprises information that indicates the maximum number of registered UEs or PDU sessions for the HPLMN mapped network slice. The method further comprises, at the NSACF in the VPLMN of the UE, receiving the update request from the network node, storing the information that indicates the maximum number of registered UEs or PDU sessions for the HPLMN mapped network slice, and applying the maximum number of registered UEs or PDU sessions for the HPLMN mapped network slice to process the update request.

In one embodiment, the network node is an Access and Mobility Management Function (AMF), and the information that indicates the maximum number of registered UEs or PDU sessions for the HPLMN mapped network slice is information that indicates the maximum number of registered UEs for the HPLMN mapped network slice.

In one embodiment, the network node is a Session Management Function (SMF), and the information that indicates the maximum number of registered UEs or PDU sessions for the HPLMN mapped network slice is information that indicates the maximum number of PDU sessions for the HPLMN mapped network slice.

In one embodiment, the method further comprises, at a UDM or Unified Data Repository (UDR) in the HPLMN of the UE, receiving an updated, or changed, maximum number of registered UEs or PDU sessions for the HPLMN mapped network slice and notifying a second network node in the VPLMN of the UE of the updated maximum number of registered UEs or PDU sessions for the HPLMN mapped network slice, wherein the second node may or may not be the same as the network node. The method further comprises, at the second network node in the VPLMN of the UE, receiving the notification from the UDM or UDR and sending, to the NSACF in the VPLMN of the UE, a second update request comprising information that indicates the updated maximum number of registered UEs or PDU sessions for the HPLMN mapped network slice. The method further comprises, at the NSACF in the VPLMN of the UE, receiving the second update request and storing the updated maximum number of registered UEs or PDU sessions for the HPLMN mapped network slice for subsequent application by the NSACF.

In one embodiment, a method performed by a network node in a VPLMN of a UE comprises receiving, from the UE, a request comprising information that indicates a particular network slice that is subject to NSAC and obtaining subscription data that comprises information that indicates a maximum number of registered UEs or PDU sessions for a HPLMN mapped network slice associated to the particular network slice indicated by the request received by the network node in the VPLMN. The method further comprises sending an update request to a NSACF in the VPLMN of the UE, wherein the update request a request to update a number of registered UEs or a number of PDU sessions for the HPLMN mapped network slice and the update request comprises information that indicates the maximum number of registered UEs or PDU sessions for the HPLMN mapped network slice.

In one embodiment, the network node is an AMF, and the information that indicates the maximum number of registered UEs or PDU sessions for the HPLMN mapped network slice is information that indicates the maximum number of registered UEs for the HPLMN mapped network slice.

In one embodiment, the network node is a SMF, and the information that indicates the maximum number of registered UEs or PDU sessions for the HPLMN mapped network slice is information that indicates the maximum number of PDU sessions for the HPLMN mapped network slice.

In one embodiment, the method further comprises receiving, from a UDM or UDR in the HPLMN of the UE, a notification of an updated maximum number of registered UEs or PDU sessions for the HPLMN mapped network slice and sending, to the NSACF in the VPLMN of the UE, a second update request comprising information that indicates the updated maximum number of registered UEs or PDU sessions for the HPLMN mapped network slice.

In one embodiment, a network node for a VPLMN of a UE comprises processing circuitry configured to cause the network node to receive, from the UE, a request comprising information that indicates a particular network slice that is subject to NSAC and obtain subscription data that comprises information that indicates a maximum number of registered UEs or PDU sessions for a HPLMN mapped network slice associated to the particular network slice indicated by the request received by the network node in the VPLMN. The processing circuitry is further configured to cause the network node to send an update request to a NSACF in the VPLMN of the UE, wherein the update request a request to update a number of registered UEs or a number of PDU sessions for the HPLMN mapped network slice and the update request comprises information that indicates the maximum number of registered UEs or PDU sessions for the HPLMN mapped network slice.

In one embodiment, a method performed by a NSACF in a VPLMN of a UE comprises receiving an update request from a network node in the VPLMN of the UE, wherein the update request is a request to update a number of registered UEs or a number of Protocol Data Unit, PDU, sessions for a HPLMN mapped network slice and the update request comprises information that indicates the maximum number of registered UEs or PDU sessions for the HPLMN mapped network slice. The method further comprises storing the information that indicates the maximum number of registered UEs or PDU sessions for the HPLMN mapped network slice and applying the maximum number of registered UEs or PDU sessions for the HPLMN mapped network slice to process the update request.

In one embodiment, the network node is an AMF, and the information that indicates the maximum number of registered UEs or PDU sessions for the HPLMN mapped network slice is information that indicates the maximum number of registered UEs for the HPLMN mapped network slice.

In one embodiment, the network node is a SMF, and the information that indicates the maximum number of registered UEs or PDU sessions for the HPLMN mapped network slice is information that indicates the maximum number of PDU sessions for the HPLMN mapped network slice.

In one embodiment, the method further comprises receiving a second update request from a second network node, which may or may not be the same as the network node, wherein the second update request comprises information that indicates an updated maximum number of registered UEs or PDU sessions for the HPLMN mapped network slice. The method further comprises storing the updated maximum number of registered UEs or PDU sessions for the HPLMN mapped network slice for subsequent application by the NSACF.

In one embodiment, a network node that implements a NSACF in a VPLMN of a UE comprises processing circuitry configured to cause the network node to receive an update request from a network node in the VPLMN of the UE, wherein the update request is a request to update a number of registered UEs or a number of PDU sessions for a HPLMN mapped network slice and the update request comprises information that indicates the maximum number of registered UEs or PDU sessions for the HPLMN mapped network slice. The processing circuitry is further configured to cause the network node to store the information that indicates the maximum number of registered UEs or PDU sessions for the HPLMN mapped network slice and apply the maximum number of registered UEs or PDU sessions for the HPLMN mapped network slice to process the update request.

In one embodiment, a method performed by a UDM or UDR in a HPLMN of a UE comprises receiving an updated, or changed, maximum number of registered UEs or PDU sessions for a HPLMN mapped network slice and notifying a network node in a VPLMN of the UE of the updated maximum number of registered UEs or PDU sessions for the HPLMN mapped network slice.

In one embodiment, the network node is an AMF, and the updated maximum number of registered UEs or PDU sessions for the HPLMN mapped network slice is an updated maximum number of registered UEs for the HPLMN mapped network slice.

In one embodiment, the network node is a SMF, and the updated maximum number of registered UEs or PDU sessions for the HPLMN mapped network slice is an updated maximum number of PDU sessions for the HPLMN mapped network slice.

In one embodiment, a network node that implements a UDM or UDR in a HPLMN of a UE comprises processing circuitry configured to cause the network node to receive an updated, or changed, maximum number of registered UEs or PDU sessions for a HPLMN mapped network slice and notify a network node (200; 206) in a VPLMN of the UE of the updated maximum number of registered UEs or PDU sessions for the HPLMN mapped network slice.

In one embodiment, a method comprises, at a NSACF in a VPLMN of a UE, receiving an update request from a network node in the VPLMN of the UE where the update request is a request to update a number of registered UEs or a number of PDU sessions for a particular network slice that corresponds to a HPLMN mapped network slice and sending a request to a network node in a HPLMN of the UE for a maximum number of registered UEs or PDU session for the HPLMN mapped network slice. The method further comprises, at the network node in the HPLMN of the UE, receiving the request from the NSACF and sending a response to the NSACF, the response comprising information that indicates the maximum number of registered UEs or PDU session for the HPLMN mapped network slice. The method further comprises, at the NSACF in the VPLMN of the UE, receiving the response from the network node in the HPLMN of the UE comprising the information that indicates the maximum number of registered UEs or PDU session for the HPLMN mapped network slice and applying the maximum number of registered UEs or PDU session for the HPLMN mapped network slice when processing the update request.

In one embodiment, a method performed by a NSACF in a VPLMN of a UE comprises, receiving an update request from a network node in the VPLMN of the UE, the update request being a request to update a number of registered UEs or a number of PDU sessions for a particular network slice that corresponds to a HPLMN mapped network slice. The method further comprises obtaining, from a network node in a HPLMN of the UE, information that indicates a maximum number of registered UEs or PDU session for the HPLMN mapped network slice and applying the maximum number of registered UEs or PDU session for the HPLMN mapped network slice when processing the update request.

In one embodiment, a network node that implements a NSACF for a VPLMN of a UE comprises processing circuitry configured to cause the network node to receive an update request from a network node in the VPLMN of the UE, the update request being a request to update a number of registered UEs or a number of PDU sessions for a particular network slice that corresponds to a HPLMN mapped network slice. The processing circuitry is further configured to cause the network node to obtain, from a network node in a HPLMN of the UE, information that indicates a maximum number of registered UEs or PDU session for the HPLMN mapped network slice and apply the maximum number of registered UEs or PDU session for the HPLMN mapped network slice when processing the update request.

In one embodiment, a method performed by a network node in a HPLMN of a UE comprises receiving a request from a NSACF in a VPLMN of the UE, the request being a request for a maximum number of registered UEs or PDU sessions for a particular network slice associated to a HPLMN mapped network slice. The method further comprises sending a response to the NSACF in the VPLMN of the UE, the response comprising information that indicates the maximum number of registered UEs or PDU session for the HPLMN mapped network slice.

In one embodiment, a network node for a HPLMN of a UE comprises processing circuitry configured to cause the network node to receive a request from a NSACF in a VPLMN of the UE, the request being a request for a maximum number of registered UEs or PDU sessions for a particular network slice associated to a HPLMN mapped network slice. The processing circuitry is further configured to cause the network node to send a response to the NSACF in the VPLMN of the UE, the response comprising information that indicates the maximum number of registered UEs or PDU session for the HPLMN mapped network slice.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates one example of a cellular communications system 100 in which embodiments of the present disclosure may be implemented;

FIGS. 2A and 2B illustrate example embodiments of the cellular communication system of FIG. 1;

FIG. 3 illustrates an example roaming architecture for the cellular communications system of FIG. 1;

FIGS. 4A and 4B illustrate an embodiment of the present disclosure in accordance with a first option;

FIG. 5 illustrates an embodiment of the present disclosure in accordance with a second option;

FIGS. 6A and 6B are modified version of FIGS. 4A and 4B for the embodiment for Option 1 related to maximum number of Protocol Data Unit (PDU) sessions, in accordance with another embodiment of the present disclosure;

FIG. 7 illustrates an embodiment of the present disclosure in accordance with a third option;

FIG. 8 illustrates the operation of an Access and Mobility Management Function (AMF) in a Visited Public Land Mobile Network (VPLMN) and either a Network Slice Admission Control Function (NSACF) in a Home Public Land Mobile Network (HPLMN) or a NSACF in the VPLMN, in accordance with an embodiment of the present disclosure;

FIG. 9 illustrates the operation of a Session Management Function (SMF) in a VPLMN and either a NSACF in a HPLMN or a NSACF in the VPLMN, in accordance with an embodiment of the present disclosure;

FIG. 10 illustrates a discovery procedure in accordance with one embodiment of the present disclosure; and

FIGS. 11, 12, and 13 are schematic block diagrams of example embodiments of a network node.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

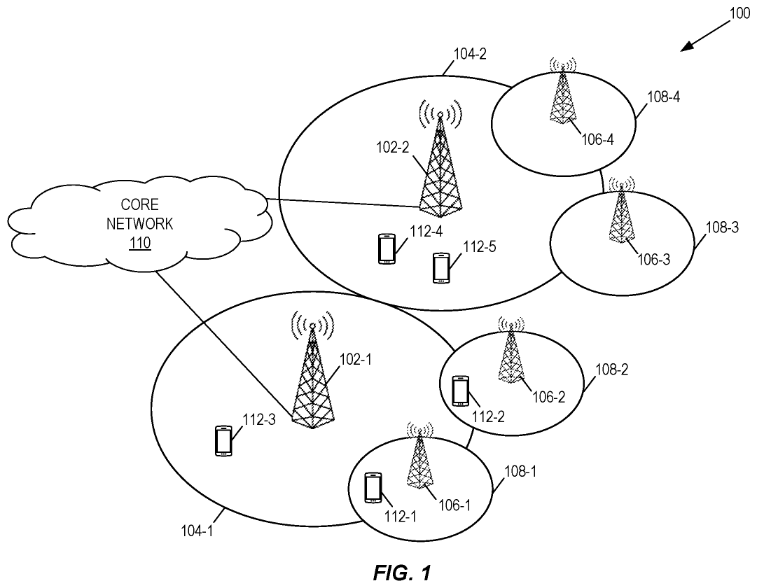

FIG. 1 illustrates one example of a cellular communications system 100 in which embodiments of the present disclosure may be implemented. In the embodiments described herein, the cellular communications system 100 is a 5G system (5GS) including a Next Generation RAN (NG-RAN) and a 5G Core (5GC); however, the present disclosure is not limited thereto. In this example, the RAN includes base stations 102-1 and 102-2, which in the 5GS include NR base stations (gNBs) and optionally next generation eNBs (ng-eNBs) (e.g., LTE RAN nodes connected to the 5GC), controlling corresponding (macro) cells 104-1 and 104-2. The base stations 102-1 and 102-2 are generally referred to herein collectively as base stations 102 and individually as base station 102. Likewise, the (macro) cells 104-1 and 104-2 are generally referred to herein collectively as (macro) cells 104 and individually as (macro) cell 104. The RAN may also include a number of low power nodes 106-1 through 106-4 controlling corresponding small cells 108-1 through 108-4. The low power nodes 106-1 through 106-4 can be small base stations (such as pico or femto base stations) or RRHs, or the like. Notably, while not illustrated, one or more of the small cells 108-1 through 108-4 may alternatively be provided by the base stations 102. The low power nodes 106-1 through 106-4 are generally referred to herein collectively as low power nodes 106 and individually as low power node 106. Likewise, the small cells 108-1 through 108-4 are generally referred to herein collectively as small cells 108 and individually as small cell 108. The cellular communications system 100 also includes a core network 110, which in the 5G System (5GS) is referred to as the 5GC. The base stations 102 (and optionally the low power nodes 106) are connected to the core network 110.

The base stations 102 and the low power nodes 106 provide service to wireless communication devices 112-1 through 112-5 in the corresponding cells 104 and 108. The wireless communication devices 112-1 through 112-5 are generally referred to herein collectively as wireless communication devices 112 and individually as wireless communication device 112. In the following description, the wireless communication devices 112 are oftentimes UEs and as such sometimes referred to herein as UEs 112, but the present disclosure is not limited thereto.

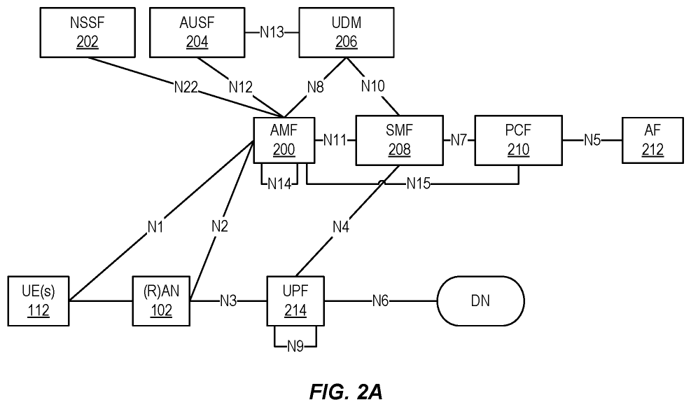

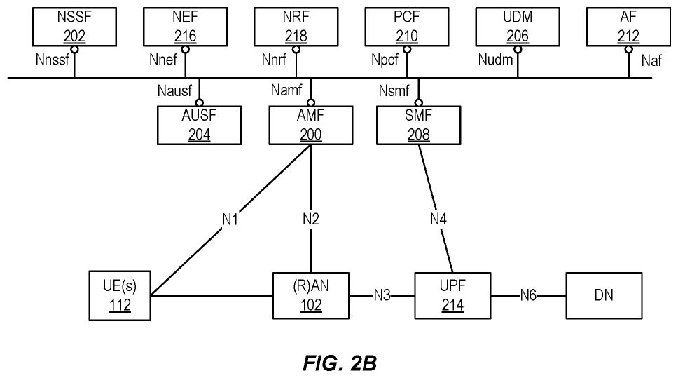

FIG. 2A illustrates a wireless communication system represented as a 5G network architecture composed of core Network Functions (NFs), where interaction between any two NFs is represented by a point-to-point reference point/interface. FIG. 2A can be viewed as one particular implementation of the system 100 of FIG. 1.

Seen from the access side the 5G network architecture shown in FIG. 2A comprises a plurality of UEs 112 connected to either a RAN 102 or an Access Network (AN) as well as an AMF 200. Typically, the R(AN) 102 comprises base stations, e.g. such as eNBs or gNBs or similar. Seen from the core network side, the 5GC NFs shown in FIG. 2 include a NSSF 202, an AUSF 204, a UDM 206, the AMF 200, a SMF 208, a PCF 210, and an Application Function (AF) 212.

Reference point representations of the 5G network architecture are used to develop detailed call flows in the normative standardization. The N1 reference point is defined to carry signaling between the UE 112 and AMF 200. The reference points for connecting between the AN 102 and AMF 200 and between the AN 102 and UPF 214 are defined as N2 and N3, respectively. There is a reference point, N11, between the AMF 200 and SMF 208, which implies that the SMF 208 is at least partly controlled by the AMF 200. N4 is used by the SMF 208 and UPF 214 so that the UPF 214 can be set using the control signal generated by the SMF 208, and the UPF 214 can report its state to the SMF 208. N9 is the reference point for the connection between different UPFs 214, and N14 is the reference point connecting between different AMFs 200, respectively. N15 and N7 are defined since the PCF 210 applies policy to the AMF 200 and SMF 208, respectively. N12 is required for the AMF 200 to perform authentication of the UE 112. N8 and N10 are defined because the subscription data of the UE 112 is required for the AMF 200 and SMF 208.

The 5GC network aims at separating UP and CP. The UP carries user traffic while the CP carries signaling in the network. In FIG. 2, the UPF 214 is in the UP and all other NFs, i.e., the AMF 200, SMF 208, PCF 210, AF 212, NSSF 202, AUSF 204, and UDM 206, are in the CP. Separating the UP and CP guarantees each plane resource to be scaled independently. It also allows UPFs to be deployed separately from CP functions in a distributed fashion. In this architecture, UPFs may be deployed very close to UEs to shorten the Round Trip Time (RTT) between UEs and data network for some applications requiring low latency.

The core 5G network architecture is composed of modularized functions. For example, the AMF 200 and SMF 208 are independent functions in the CP. Separated AMF 200 and SMF 208 allow independent evolution and scaling. Other CP functions like the PCF 210 and AUSF 204 can be separated as shown in FIG. 2A. Modularized function design enables the 5GC network to support various services flexibly.

Each NF interacts with another NF directly. It is possible to use intermediate functions to route messages from one NF to another NF. In the CP, a set of interactions between two NFs is defined as service so that its reuse is possible. This service enables support for modularity. The UP supports interactions such as forwarding operations between different UPFs.

FIG. 2B illustrates a 5G network architecture using service-based interfaces between the NFs in the CP, instead of the point-to-point reference points/interfaces used in the 5G network architecture of FIG. 2A. However, the NFs described above with reference to FIG. 2A correspond to the NFs shown in FIG. 2B. The service(s) etc. that a NF provides to other authorized NFs can be exposed to the authorized NFs through the service-based interface. In FIG. 2B the service based interfaces are indicated by the letter “N” followed by the name of the NF, e.g. Namf for the service based interface of the AMF 200 and Nsmf for the service based interface of the SMF 208, etc. The NEF 216 and the NRF 218 in FIG. 2B are not shown in FIG. 2A discussed above. However, it should be clarified that all NFs depicted in FIG. 2A can interact with the NEF 216 and the NRF 218 of FIG. 2B as necessary, though not explicitly indicated in FIG. 2A.

Some properties of the NFs shown in FIGS. 2A and 2B may be described in the following manner. The AMF 200 provides UE-based authentication, authorization, mobility management, etc. A UE 112 even using multiple access technologies is basically connected to a single AMF 200 because the AMF 200 is independent of the access technologies. The SMF 208 is responsible for session management and allocates Internet Protocol (IP) addresses to UEs. It also selects and controls the UPF 214 for data transfer. If a UE 112 has multiple sessions, different SMFs 208 may be allocated to each session to manage them individually and possibly provide different functionalities per session. The AF 212 provides information on the packet flow to the PCF 210 responsible for policy control in order to support QoS. Based on the information, the PCF 210 determines policies about mobility and session management to make the AMF 200 and SMF 208 operate properly. The AUSF 204 supports authentication function for UEs or similar and thus stores data for authentication of UEs or similar while the UDM 206 stores subscription data of the UE 112. The Data Network (DN), not part of the 5GC network, provides Internet access or operator services and similar.

An NF may be implemented either as a network element on a dedicated hardware, as a software instance running on a dedicated hardware, or as a virtualized function instantiated on an appropriate platform, e.g., a cloud infrastructure.

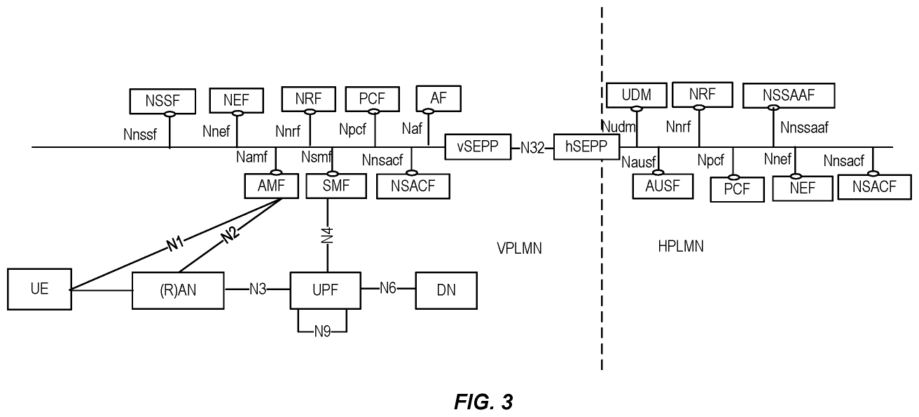

FIG. 3 illustrates a wireless communication system represented as an example 5G network roaming architecture composed of core Network Functions (NFs), where interaction between any two NFs is represented by a point-to-point reference point/interface. FIG. 3 can be viewed as one particular implementation of the system 100 of FIG. 1. While the details of the various nodes illustrated in FIG. 3 are known to those of skill in the art, while not essential for understanding the present disclosure, the interested reader is directed to 3GPP 23.501 (see, e.g., V17.1.1).

### 1 Embodiments Related to First Aspects of the Present Disclosure

There currently exist certain challenges. 3GPP Release 17 proposed Home Public Land Mobile Network (HPLMN) or Visited Public Land Mobile Network (VPLMN) control for roaming subscribers, when it comes to using network slices subject to admission control for the number of registered UEs. HPLMN control means that the VPLMN (e.g., Access and Mobility Management Function (AMF) or a Network Slice Admission Control Function (NSACF) in VPLMN) performs admission with a home Network Slice Admission Control (NSAC) for registration for registering UEs and for Local Break Out (LBO) Protocol Data Unit (PDU) sessions. For VPLMN control included in Release 17, the VPLMN performs admission with NSAC in the VPLMN for registration, based on a pre-configured maximum number of Registered UEs, and number of LBO PDU sessions. This pre-configuration of the maximum number of registered UE in VPLMN was seen as a limitation for that approach.

Certain aspects of the present disclosure and their embodiments may provide solutions to the aforementioned or other challenges. Embodiments of the solutions described herein remove the need for pre-configuration of any information (related to NSAC) in the VPLMN and may allow for a more dynamic support for VPLMN admission control, e.g., enables real-time change to the number of registered UEs (or number of PDU sessions) to be admitted in case of VPLMN control for any domain with whom the VPLMN has a roaming agreement.

Certain embodiments may provide one or more of the following technical advantage(s). Embodiments of the present disclosure provide solution(s) to support VPLMN admission control for network slices subject to admission restrictions for the number for registered UEs (or number of PDU sessions) without requiring pre-configuration.

Three options are proposed: Option 1 is an AMF based option, Option 2 is an NSACF based option, and Option 3 is a UDR option

Note that the UDM (e.g., the UDM in the HPLMN in the roaming scenario) maintains UE subscription data, but as to avoid NFs retrieving the full UE subscription data of a UE 112, the 3GPP specifications support different “subscription data types” that group different parts of the UE subscription data, and the split can be to separate the UE subscription data from a functional perspective or what is assumed to be needed by a certain NF. One NF can, in one “Get” operation, retrieve data for one or more subscription data types. See Table 5.2.3.3.1-1: UE Subscription data types in 3GPP TS 23.502 for the list of the current subscription data types. For example, there is an Access and Mobility Subscription data type (data needed for UE Registration and Mobility Management), while the AMF 200 in some cases also gets, e.g., “Slice Selection Subscription data” and “SMF Selection Subscription data”, as these may be needed for various AMF logic. However, for the description herein, the term “UE subscription data” is used. For example, the phrase “UE subscription data obtained by the AMF 200” may refer to one or more subscription data types that are obtained by the AMF 200.

### 1.1 Option 1: AMF-based Option

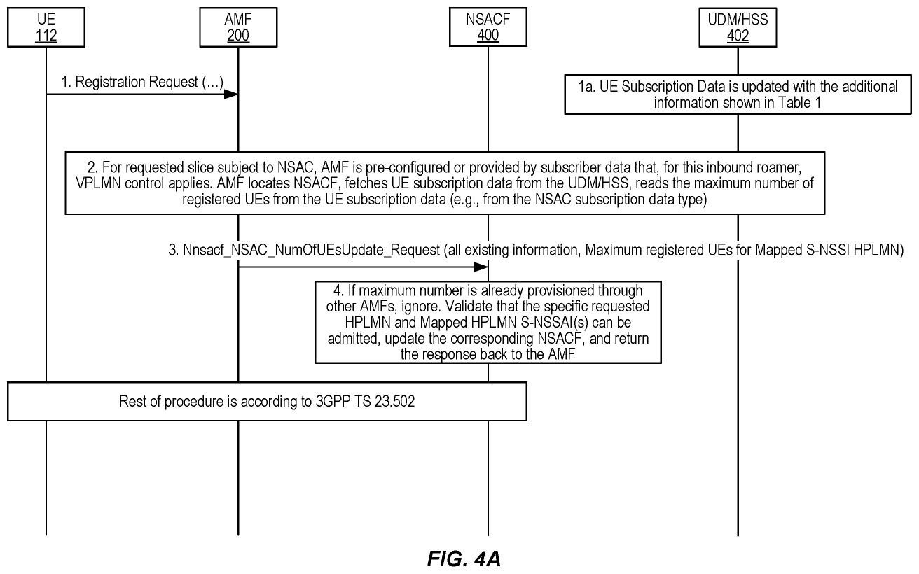

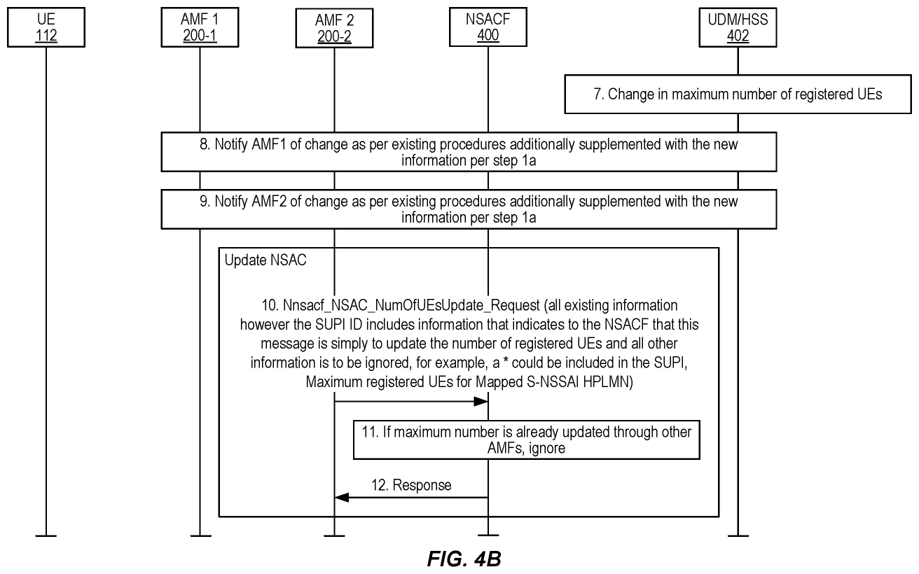

FIGS. 4A and 4B illustrate an embodiment of the present disclosure in accordance with Option 1. The procedure involves a UE 112, an AMF 200, a NSACF 400, and a UDM/HSS 402. The AMF 200 and the NSACF 400 are, in this example, located in a VPLMN of the UE 112, whereas the UDM/HSS 402 is located in a HPLMN of the UE 112. In this option, the AMF 200 receives information about a maximum number of registered UEs to be admitted (e.g., for a particular network slice) in a VPLMN of the UE 112 as part of UE subscription data, which is extended to include this additional information (e.g., in a new subscription data type which may be “NSAC Subscription data”). The AMF 200 may also receive information about the number of allowed LBO PDU sessions. The AMF 200 updates the NSACF 400 with this information, any time the HPLMN of the UE 112 (e.g., UDM) changes the AMF subscription data.

The call flow of FIGS. 4A and 4B implements the above option. The call flow shows only relevant steps to describe the new behavior associated with this option. As will be appreciated by those of ordinary skill in the art, other steps may also be performed.

The steps are described below:
Step 1a: In step 1a, UE subscription data is updated at the UDM/HSS 402 with additional information that indicates: (a) HPLMN or VPLMN control for S-NSSAIs subject to NSAC and/or (b) maximum number of registered UEs to be applied in the VPLMN when VPLMN admission control applies. In one example, this additional information is as shown below in Table 1. The UE subscription data returned to the AMF 200 in step 2 depends on the VPLMN where the subscriber (associated to the UE 112) is roaming, i.e. is VPLMN specific. The additional data can be part of a new subscription data type (for the UE subscription data) dedicated for NSAC on number of registered UEs or included in another subscription data type, as shown in the example of Table 1.

TABLE 1
New Information in UE Subscription Data

| | | |
|---|---|---|
| NSAC | HPLMN or VPLMN | In a roaming case, and for a |
| Subscription | control for S-NSSAIs | subscribed S-NSSAI for the Serving |
| data (data | subject to NSAC | PLMN subject to NSAC, it indicates |
| needed for | (Optional) | whether HPLMN or VPLMN control |
| applying NSAC | | applies. |
| for number of | Maximum number of | It indicates the maximum number of |
| registered UEs) | registered UEs (VPLMN | registered UEs to be applied in the |
| | control) | VPLMN (i.e. only applicable when |
| | | VPLMN control applies) |

Step 1: In step 1, the UE 112 issues a Registration request, e.g., as per existing procedures in 3GPP TS 23.502. The registration request is for a particular network slice. In this example, the particular network slice is indicated by a particular S-NSSAI.
Step 2: In step 2, the AMF 200 may be pre-configured or provided via subscriber data (e.g., via UE subscription data) with information that for the HPLMN mapped S-NSSAI slice for the specific HPLMN, VPLMN control is required. The AMF 200 locates the applicable NSACF, e.g., based on existing procedures. Alternatively, the AMF 200 can determine if HPLMN or VPLMN control is used for slice admission from the UE subscription data without needing to be configured for that purpose. The AMF 200 fetches the UE subscription data including the additional information per step 1a. The AMF reads the maximum number of Registered UEs per subscribed Single Network Slice Assistance Information (S-NSSAI) (i.e., per subscribed network slice) that is subject for NSAC from the received UE subscription data. Note that, in one embodiment, the AMF 200 does one “get”, or fetch, operation and can get multiple set of subscription data types via this one get operation. When VPLMN control applies, then UDM creates/provides the max number for the specific VPLMN.
Step 3: In step 3, the AMF 200 sends a Nnsacf_NSAC_NumOfUEsUpdate_Request to the NSACF 400 and includes the additional information for the maximum number of registered UEs for the specific HPLMN and Mapped HPLMN S-NSSAI. Note that, for the AMF 200, a subscribed S-NSSAI is the same as a Mapped HPLMN S-NSSAI.
Step 4: In step 4, if the NSACF 400 already has this information available for other AMFs, it just ignores the additional information for the maximum number of registered UEs for the specific HPLMN and Mapped HPLMN S-NSSAI, unless the value has changed from the stored value. Otherwise, the AMF 200 stores the maximum number of registered UEs for the specific HPLMN and Mapped HPLMN S-NSSAI. The NSACF 400 validates that the specific requested HPLMN and Mapped HPLMN S-NSSAI(s) can be admitted, updates the corresponding NSACF, and returns the response back to the AMF 200, based on existing procedures in TS 23.502.
If in step 3, the requested S-NSSAI(s) is admitted, the procedure continues to register the S-NSSAIs in the network and return the appropriate response to the UE 112 in accordance with 3GPP TS 23.502.
Step 7: In step 7, the UDM 402 (or UDR, and UDM gets the update from UDR), through Operation and Management (O&M), performed a change to the number of Registered UEs for the VPLMN.
Step 8: In step 8, all AMFs who have subscribed to be notified of such changes are notified of that change. This includes, in this example, an AMF denoted as AMF 200-1 (“AMF 1”). The notification of the change may include information that directly indicates the updated maximum number of registered UEs or that indirectly indicates the updated maximum number of registered UEs (e.g., as a delta value to be added to or subtracted from the previous value of the maximum number of registered UEs).
Step 9: Similar to step 8, another AMF 200-2 (“AMF 2”) is also notified. Indeed, all AMFs that subscribed will be notified. The notification of the change may include information that directly indicates the updated maximum number of registered UEs or that indirectly indicates the updated maximum number of registered UEs (e.g., as a delta value to be added to or subtracted from the previous value of the maximum number of registered UEs).
Steps 10-12: In steps 10-12, all AMFs informed of the change will update the NSACF 400. The call flow shows only one AMF (i.e., AMF 200-2) doing this for brevity. This step can be done immediately by the AMF 200-2 without admission check or during an admission check to be performed. As shown, the AMF 200-2 sends, to the NSACF 400, the Nnsacf_NSAC_NumOfUEsUpdate_Request and includes the updated maximum number of registered UEs. To enable the NSACF 400 to distinguish this request where admission in not required when the purpose is to simply update the NSACF 400 with the new information, the request includes a special SUPI for that purpose (e.g., a special SUPI that is, e.g., all “***” as example for that purpose). Other options can be also possible such as introducing a new control parameter, or new value for the update flag indicating only value for maximum number of registered UEs been updated making the NSACF 400 to ignore SUPI etc. Regardless, the NSACF 400 updates the new information in storage. The NSACF 400 may need to deal with the potential of receiving multiple updates from several AMFs to ensure that the data is correctly updated. If the maximum number of registered UEs has already been updated by another AMF, the NSACF 400 ignores the update from the AMF 200-2. The NSACF 400 may send a response to the AMF 200-2, e.g., indicating that the update is complete.

### 1.2 Option 2: NSACF-Based Option

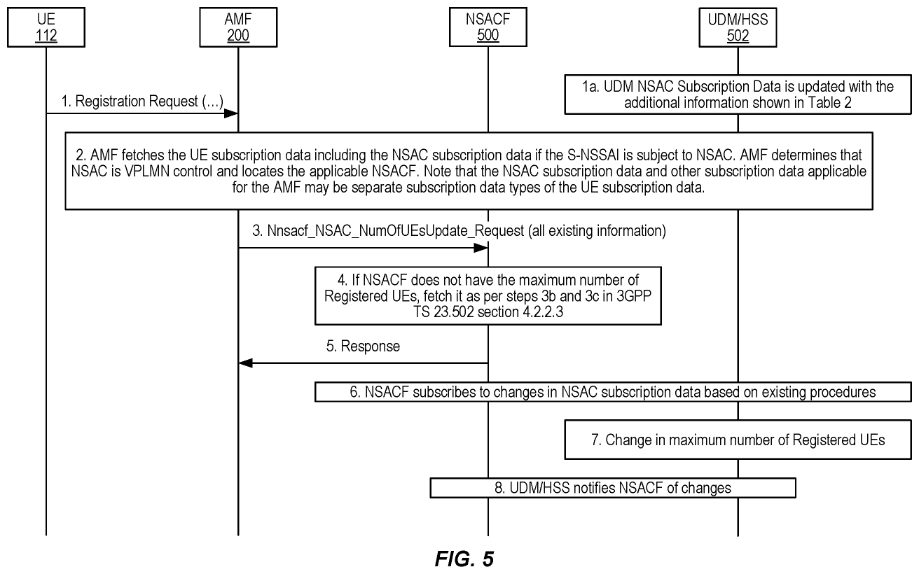

FIG. 5 illustrates an embodiment of the present disclosure in accordance with Option 2. The procedure involves a UE 112, an AMF 200, a NSACF 500, and a UDM/HSS 502. While this example uses the AMF 200, the same procedure can be used for an SMF. In this option, the NSACF 500 fetches the information for the maximum number of registered UEs in the VPLMN as part of the Slice selection subscription data which is extended to include this additional information or in a new Subscription data type. Any changes to this information will be reported to the NSACF 500, e.g., in real time, and the NSACF 500 can apply the updated information immediately.

The call flow of FIG. 5 implements the above option. The call flow shows only relevant steps to describe the new behavior associated with this option. As will be appreciated by those of ordinary skill in the art, other steps may also be performed.
Step 1a: In step 1a, UE subscription data (e.g., UDM UE Slice selection subscription data) is updated with additional information shown in Table 2, which includes a new subscription data type related to NSAC that can be fetched when needed. The returned information in step 2 to the AMF 200 depends on the VPLMN where the subscriber is roaming.

TABLE 2

| | | |
|---|---|---|
| NSAC | HPLMN or VPLMN | In a roaming case, and for a |
| Subscription | control for S-NSSAIs | subscribed S-NSSAI for the |
| data (data | subject to NSAC | Serving PLMN subject to |
| needed for | | NSAC, it indicates whether |
| applying | | HPLMN or VPLMN control |
| NSAC for | | applies. |
| number of | Maximum number of | It indicates the maximum |
| registered | registered UEs | number of registered UEs to be |
| UEs) | (VPLMN control) | applied in the VPLMN (i.e. only |
| | | applicable when VPLMN control |
| | | applies) |
| NSAC | HPLMN or VPLMN | In a roaming case, and for a |
| Subscription | control for S-NSSAIs | subscribed S-NSSAI for the |
| data (data | subject to NSAC | Serving PLMN subject to |
| needed for | | NSAC, it indicates whether |
| applying | | HPLMN or VPLMN control |
| NSAC for | | applies. |
| maximum | Maximum number of | It indicates the maximum |
| number pf | LBO sessions | number of PDU LBO session to |
| PDU LBO | (VPLMN control) | be applied in the VPLMN (i.e. |
| sessions) | | only applicable when VPLMN |
| | | control applies) |

Step 1: In step 1, the UE 112 issues a Registration request, e.g., as per existing procedures in 3GPP TS 23.502. The registration request is at least for a particular network slice. In this example, the particular network slice is indicated by a particular S-NSSAI.
Step 2: In step 2, the AMF 200 fetches the UE subscription data (e.g., one or more subscription data types applicable to the AMF 200) including the NSAC subscription data, in step 1a Table 2, if the S-NSSAI is subject to NSAC. The AMF 200 determines that NSAC is VPLMN control using the retrieved NSAC subscription data, and locates the applicable NSACF, e.g., based on existing procedures (e.g., configuration or NRF lookup). Note that the NSAC subscription data and other subscription data applicable for the AMF 200 may be separate subscription data types of the UE subscription data.
Alternatively in step 2, the AMF 200 fetches the UE subscription data (e.g., one or more subscription data types applicable to the AMF 200) which may include NSAC subscription data indicating whether VPLMN or HPLMN control should be applied. If the S-NSSAI is subject to NSAC, the AMF 200 locates an NSACF in the visited network, e.g., based on existing procedures (e.g., configuration or NRF lookup).
Step 3: In step 3, the AMF 200 sends a Nnsacf_NSAC_NumOfUEsUpdate_Request to the NSACF 500, e.g., according to existing procedures in 3GPP TS 23.502.
According to an embodiment, the AMF includes, in the request of step 3, the subscription data indicating whether VPLMN or HPLMN control should be applied.
Step 4: In step 4, if required, the NSACF 500 fetches the NSAC subscription data using existing procedures in TS 23.502.
Step 5: In step 5, the NSACF 500 returns the update response to the AMF 200.
In one embodiment, the update response includes the maximum number of registered UEs for the requested S-NSSAI (s)
Step 6: In step 6, the NSACF 500 subscribes for any changes to the NSAC subscription data.
Steps 7-8: In steps 7-8, if there is a change in the number registered UE data by HPLMN, the NSACF 500 is notified and applies the new information.

In another embodiment, after step 3, the NSACF 500 obtains, from the AMF 200 (at step 3)) or from the UDM 502, subscription data indicating whether VPLMN or HPLMN control should be applied.

Alternatively, the NSACF 500 obtains subscription information from the HPLMN indicating whether VPLMN or HPLMN control should be applied and the maximum number of registered UEs/maximum number of PDU Local Break-Out (LBO) sessions for enforcement and further subscribes with the HPLMN to any changes to the obtained information.

According to an embodiment, for any additional request(s) received in the NSACF 500 in the VPLMN exceeding the received information (i.e., maximum number of registered UEs or maximum number of LBO PDU session), the NSACF 500 interacts via the VPLMN with the HPLMN (e.g., NSACF in HPLMN) to determine whether admission is accepted or rejected (e.g., unless forbidden by the Service Level Agreement (SLA)). If an admission is accepted, the UE entry is stored in the NSACF 500 performing admission in the VPLMN.

In another embodiment, for any additional request(s) received in the NSACF 500 in the VPLMN exceeding the received information (i.e., maximum number of registered UEs or maximum number of LBO PDU sessions), the NSACF 500 in the VPLMN simply rejects the UE access to the network slice.

1.3 Extensions of Proposed Procedures for Other Slice Limitations while Roaming

Option 2 can be extended to support admission when there is a maximum number of PDU sessions to be registered in case of VPLMN control and where the number of PDU sessions can be updated by HPLMN. The only change being in step 1a, where the updated subscription data additionally or alternatively includes the maximum number of PDU sessions. This is already depicted in the Table 2 in option 2.

Option 1 can also be extended; however, in this case the SMF 208 replaces the AMF 200. In addition, the UE SMF subscription data is updated as indicated in Tables 3 and 4 below. This replaces the AMF subscription data in the AMF case. Alternatively, a new SMF NSACF new subscription data type can be used for that purpose as per Table 4 below.

TABLE 3

| SMF Selection | SUPI | Key |
|---|---|---|
| Subscription | SMF Selection Subscription data contains one or more | |
| data (data | S-NSSAI level subscription data: | |
| needed for SMF | S-NSSAI | Indicates the value of the S-NSSAI. |
| Selection as | Subscribed DNN list | List of the subscribed DNNs for the |
| described | | UE (NOTE 1). |
| in clause 6.3.2 | Default DNN | The default DNN if the UE does not |
| of TS 23.501 [2]) | | provide a DNN (NOTE 2). |
| | NSAC Subscription | In a roaming case, and for a |
| | data (data needed | subscribed S-NSSAI for the |
| | for applying NSAC for | Serving PLMN subject to |
| | maximum number pf | NSAC, it indicates whether |
| | PDU LBO sessions - | HPLMN or VPLMN control |
| | HPLMN or VPLMN for | applies. |
| | S-NSSAIs subject to | |
| | NSAC | |
| | NSAC Subscription | It indicates the maximum |
| | data (data needed | number of PDU LBO session to |
| | for applying NSAC for | be applied in the VPLMN (i.e. |
| | maximum number pf | only applicable when VPLMN |
| | PDU LBO sessions - | control applies) |
| | Maximum number of | |
| | LBO sessions | |
| | (VPLMN control) | |
| | DNN(s) subject to | List of DNNs that are used for aerial |
| | aerial services | services (e.g. UAS operations or C2, |
| | | etc.) as described in TS 23.256 [80]. |
| | | (see NOTE 13). |
| | LBO Roaming | Indicates whether LBO roaming is |
| | Information | allowed per DNN, or per (S-NSSAI, |
| | | subscribed DNN). |
| | Interworking with EPS | Indicates whether EPS interworking is |
| | indication list | supported per (S-NSSAI, subscribed |
| | | DNN). |
| | Same SMF for Multiple | Indication whether the same SMF for |
| | PDU Sessions to the | multiple PDU Sessions to the same |
| | same DNN and S-NSSAI | DNN and S-NSSAI is required. |
| | Invoke NEF indication | When present, indicates, per S-NSSAI |
| | | and per DNN, that NEF based |
| | | infrequent small data transfer shall |
| | | be used for the PDU Session (see |
| | | NOTE 8). |
| | SMF information for | When static IP address/prefix is used, |
| | static IP address/ | this may be used to indicate the |
| | prefix | associated SMF information per (S- |
| | | NSSAI, DNN). |

### With New Subscription Data Type:

TABLE 4

| | | |
|---|---|---|
| NSAC | HPLMN or VPLMN | In a roaming case, and for a |
| Subscription | control for S-NSSAIs | subscribed S-NSSAI for the |
| data for LBO | subject to NSAC | Serving PLMN subject to |
| (data needed | | NSAC, it indicates whether |
| for applying | | HPLMN or VPLMN control |
| NSAC) | | applies. |
| | Maximum number of | It indicates the maximum |
| | PDU Sessions with | number of PDU Sessions with |
| | LBO (VPLMN control) | LBO (i.e. only applicable when |
| | | VPLMN control applies) |

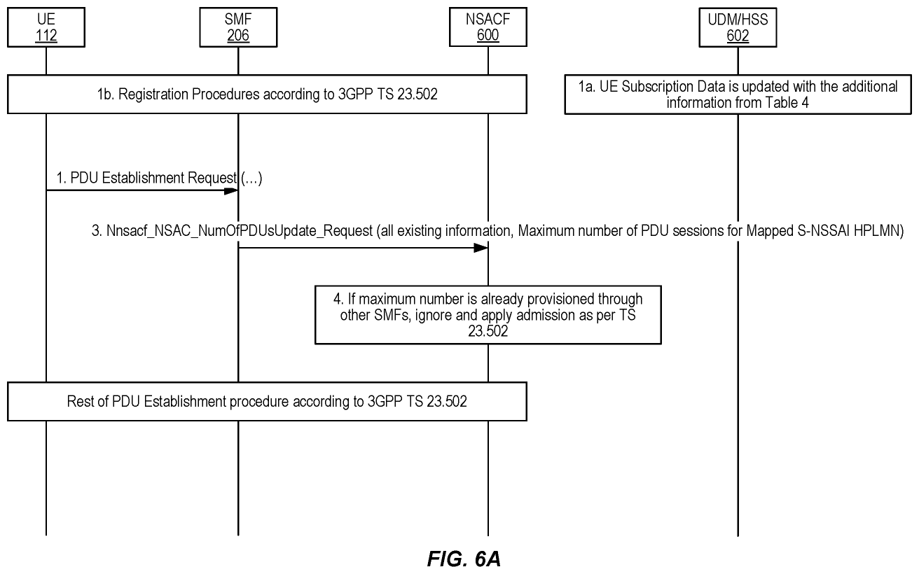

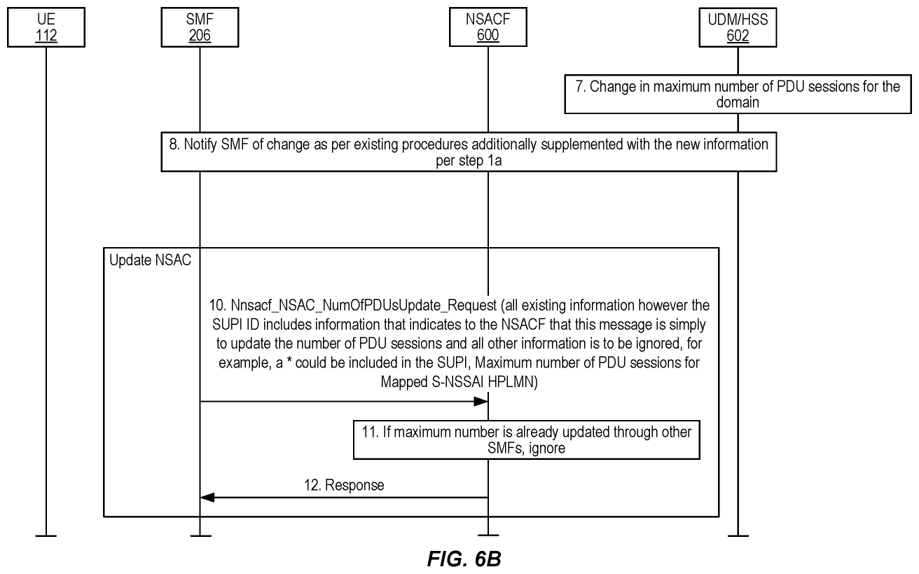

FIGS. 6A and 6B are modified version of FIGS. 4A and 4B for the embodiment for Option 1 related to maximum number of PDU sessions. The steps of FIGS. 6A and 6B involves a UE 112, a SMF 206, a NSACF 600, and a UDM/HSS 602. The steps of the procedure are as follows:
Step 1a: The UE subscription data is updated at the UDM/HSS 602 to include the additional data of Table 4.
Step 1b: The UE 112 performs a registration procedure, e.g., as described in 3GPP TS 23.502.
Step 1: The UE 112 sends a PDU Establishment Request (for a particular network slice indicated by a particular S-NSSAI) to the SMF 206. The SMF 206 obtains the UE subscription data including the additional data of Table 4.
Step 3: The SMF 206 sends a Nnsacf_NSAC_NumOfPDUsUpdate_Request that includes the existing information as well as the maximum number of PDU session for the specific HPLMN and Mapped HPLMN S-NSSAI.
Step 4: The NSACF 600 updates the maximum number of PDU sessions for the specific HPLMN and Mapped HPLMN S-NSSAI. If the number of PDU sessions for the specific HPLMN and Mapped HPLMN S-NSSAI has already been updated (e.g., by another SMF), the NSACF 600 may ignore the request as it pertains to an updated maximum number of PDU sessions for the specific HPLMN and Mapped HPLMN S-NSSAI.
The rest of the PDU establishment procedure may then be performed, e.g., according to 3GPP TS 23.502.
Step 7: In step 7, the UDM 602 (or UDR, and UDM gets the update from UDR), through Operation and Management (O&M), performed a change to the maximum number of PDU sessions for the VPLMN.
Step 8: In step 8, all SMFs who have subscribed to be notified of such changes are notified of that change. This includes, in this example, the SMF 206. Note that FIG. 6B only shows one SMF for clarity and ease of discussion, but there may be one or more SMFs that have subscribed to be notified and therefore notified of the change. The notification of the change may include information that directly indicates the updated maximum number of PDU sessions or that indirectly indicates the updated maximum number of PDU sessions (e.g., as a delta value to be added to or subtracted from the previous value of the maximum number of PDU sessions).
Steps 10-12: In steps 10-12, the SMF 206 updates the NSACF 600. This step can be done immediately by the SMF 206 without admission check or during an admission check to be performed. As shown, the SMF 206 sends, to the NSACF 600, the Nnsacf_NSAC_NumOfPDUsUpdate_Request and includes the updated maximum number of PDU sessions. To enable the NSACF 600 to distinguish this request where admission in not required when the purpose is to simply update the NSACF 600 with the new information, the request includes a special SUPI for that purpose (e.g., a special SUPI that is, e.g., all “***” as example for that purpose). Other options can be also possible such as introducing a new control parameter, or new value for the update flag indicating only value for maximum number of registered UEs been updated making the NSACF 600 to ignore SUPI etc. Regardless, the NSACF 600 updates the new information in storage. The NSACF 600 may need to deal with the potential of receiving multiple updates from several SMFs to ensure that the data is correctly updated. If the maximum number of PDU sessions has already been updated by another SMF, the NSACF 600 ignores the update from the SMF 206. The NSACF 600 may send a response to the SMF 206, e.g., indicating that the update is complete.
   1.4 Option 3 with UDR

Instead of subscribing to per UE subscription data from UDM as per above options 1 and 2, the UDR can be used to store common data. In case UDR is not able to apply logical functions on the data, then the NF consumers (AMF, NSACF, or SMF) need to apply logical function(s) on the data, e.g., to reduce the number when a new UE registers or a new PDU Session is established as per the below flow where the AMF/SMF retrieves data to decide whether HPLMN or VPLMN control applies and selected NSACF updates UDR data to keep a consistent counting of the used numbers.

In other words, instead of storing the maximum number of registered UEs and/or the maximum number of PDU sessions per S-NSSAI in the VPLMN in each of the UE subscription data associated to a particular network function (e.g., AMF subscription data, SMF subscription data, etc.) and subscribing to any changes of the corresponding UE subscription data by the network function as described in option 1 and 2, the UDR can be used to store the maximum number of registered UEs and/or the maximum number of PDU sessions per S-NSSAI in the VPLMN as common data.

TABLE 5
Exposure data stored in the UDR

| | | | Data | Data Sub |
|---|---|---|---|---|
| Category | Information | Description | key | key |
| Access and | UE location | Gives the Location or the | SUPI or | |
| mobility | | last known location of a | GPSI | |
| information | | UE (e.g. Tai, Cell | | |
| | | Id . . . both 3GPP and | | |
| | | non-3GPP access location) | | |
| | UE time zone | Current time zone for the | SUPI or | |
| | | UE | GPSI | |
| | UE Access | 3GPP access or non-3GPP | SUPI or | |
| | type | access | GPSI | |
| | UE RAT type | Determined as defined in | SUPI or | |
| | | clause 5.3.2.3 of | GPSI | |
| | | TS 23.501 [2]. | | |
| | | The values are defined in | | |
| | | TS 29.571 [70] | | |
| | UE | Registered or | SUPI or | |
| | registration | Deregistered | GPSI | |
| | state | | | |
| | UE | IDLE or CONNECTED | SUPI or | |
| | connectivity | | GPSI | |
| | state | | | |
| | UE | It indicates if the UE is | SUPI or | |
| | reachability | reachable for sending | GPSI | |
| | status | either SMS or downlink | | |
| | | data to the UE, which is | | |
| | | detected when the UE | | |
| | | transitions to CM- | | |
| | | CONNECTED state or | | |
| | | when the UE will become | | |
| | | reachable for paging, | | |
| | | e.g., Periodic Registration | | |
| | | Update timer | | |
| | UE SMS over | SMS over NAS supported | SUPI or | |
| | NAS service | or not in the UE | GPSI | |
| | status | | | |
| | UE Roaming | It indicates UE's current | SUPI or | |
| | status | roaming status (the | GPSI | |
| | | serving PLMN and/or | | |
| | | whether the UE is in its | | |
| | | HPLMN) | | |
| | UE Current | Current PLMN for the UE | SUPI or | |
| | PLMN | | GPSI | |
| Session | UE IP | UE IP address | SUPI or | PDU session |
| management | address | | GPSI | ID or DNN |
| information | PDU session | Active/released | SUPI or | PDU session |
| | status | | GPSI | ID or DNN or |
| | | | | UE IP address |
| | DNAI | DNAI | SUPI or | PDU session |
| | | | GPSI | ID or DNN or |
| | | | | UE IP address |
| | N6 traffic | N6 traffic routing | SUPI or | PDU session |
| | routing | information | GPSI | ID or DNN or |
| | information | | | UE IP address |
| NSAC | HPLMN or | HPLMN or VPLMN control | S-NSSAI | PLMN of NF |
| information | VPLMN | for S-NSSAIs subject to | | consumer |
| | control | NSAC for Number of | | |
| | | registered UEs and for | | |
| | | number of PDU Sessions | | |
| | | respectively | | |
| | Maximum | Maximum number of | S-NSSAI | PLMN of NF |
| | number of | registered UEs left for | | consumer |
| | registered | consumer. | | |
| | UEs | | | |
| | Maximum | Maximum number of PDU | S-NSSAI | PLMN of NF |
| | number of | Sessions left for | | consumer |
| | PDU Sessions | consumer | | |

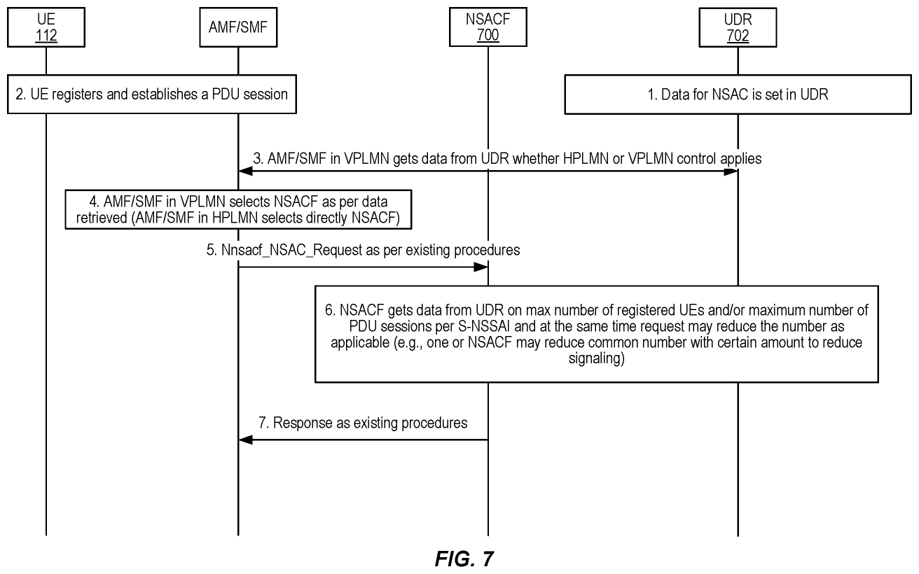

FIG. 7 illustrates a procedure in accordance with one example embodiment of the UDR-based option. The procedure involves a UE 112, an AMF or SMF (denoted as “AMF/SMF”), a NSACF 700, and a UDR 702. The steps of the procedure are as follows:
Step 1: At the UDR 702, data for NSAC is set.
Step 2: The UE 112 registers and establishes a PDU session.
Step 3: The AMF/SMF in VPLMN gets data from the UDR 702 about whether HPLMN control or VPLMN control applies.
Step 4: The AMF/SMF in the VPLMN selects the NSACF 702 as per the data retrieved in step 3.
Step 5: The AMF/SMF sends an Nnsacf_NSAC_Request (request to update number of registered UEs or to update the number of PDU sessions) to the NSACF 702.
Step 6: The NSACF 702 gets data from the UDR 702 about the maximum number of registered UEs and/or the maximum number of PDU sessions per S-NSSAI upon receiving the request of step 5. This step may be done via, e.g., SEPP and/or NEF in case AMF/SMF is outside HPLMN for security reasons. The NSACF 702 applies the obtained number for admission control.
Step 7: The NSACF 702 sends a response to the AMF/SMF, e.g., that indicates whether the maximum number of UEs or PDU sessions has been reached.

### 2 Embodiments Related to Second Aspects of the Present Disclosure

3GPP Release 17 handled outbound roamers for network slices subject to NSAC exclusively in the VPLMN, both for number of registered UEs and for Local Break Out (LBO) Protocol Data Unit (PDU) established sessions. As defined in 3GPP TS 23.501, LBO is a “[r]oaming scenario for a PDU Session where the PDU Session Anchor and its controlling SMF are located in the serving PLMN (VPLMN).” An LBO PDU established session is a session that uses only resources in the VPLMN. The SMF and user plane (UP) are in the VPLMN. The only interaction with the HPLMN is for fetching SMF subscription data and, if LBO is allowed, then no further interaction nor resources are used in HPLMN. The limitation of handling outbound roamers for network slices subject to NSAC exclusively in the VPLMN, both for number of registered UEs and for LBO PDU established sessions, is now removed by enabling HPLMN control for outbound roamers, both for number of registered UEs, as well as LBO PDU sessions. Hence, all outbound roamers for a PLMN for network slices subject to NSAC can either be VPLMN controlled or HPLMN controlled.

In addition, certain other embodiments are disclosed herein. In one embodiment, information regarding HPLMN control or VPLMN control for all roamers (e.g., outbound roamers (UEs) of a HPLMN that roam into another network or inbound roamers (UEs) from another network that roam into a VPLMN) for a PLMN (e.g., HPLMN for outbound roamers) with network slices subject to NSAC regarding the number of registered UEs is configured, or acquired when needed, by an AMF of the VPLMN.

In another embodiment, information regarding HPLMN control or VPLMN control for all roamers for a PLMN with network slices subject to NSAC regarding the number of LBO established PDU sessions (also referred to herein as “LBO PDU sessions” or “LBO sessions”), is configured, acquired, or fetched by a SMF in the VPLMN from associated UE SMF subscription data. In one embodiment, the UE SMF subscription data takes precedence over locally configured information in the SMF or other network nodes in the VPLMN, which may, e.g., be based on a Service Level Agreement (SLA) between the VPLMN and the HPLMN which is more or less static. Thus, if dynamic information is received, e.g., from subscription data, this dynamic data takes precedence over the static information.

In one embodiment, for HPLMN control of roamers, the AMF in the VPLMN interacts with an NSACF in the HPLMN dedicated for that purpose. There is no interaction with any NSACF in the VPLMN.

In one embodiment, the AMF in the VPLMN discovers (or may be pre-configured with) the NSACF in the HPLMN dedicated for that purpose. In one embodiment, the Network Repository Function (NRF) procedure is enhanced to enable the AMF to discover the NSACF in the HPLMN.

In one embodiment, for HPLMN control of roamers with LBO PDU established sessions via network slices subject to NSAC, SMF interacts with an NSACF in the HPLMN dedicated for that purpose. There is no interaction with any NSACF in the VPLMN.

Finally, for VPLMN control of roamers, both for the number of registered UEs and LBO PDU established sessions, the network slice (e.g., indicated by a Single Network Slice Assistance Information (S-NSSAI)) subject to admission in the VPLMN is a mapped network slice (e.g., S-NSSAI) for the HPLMN. This is desirable since it is the HPLMN that has a relation with the customer requiring the 5GS access, i.e. the NSAC as per the agreement between the operator and customer should be done on the S-NSSAI of the HPLMN. Additionally, the VPLMN S-NSSAI may merge more than one S-NSSAI in the HPLMN. Note that a mapped network slice (e.g., a mapped S-NSSAI) for the HPLMN is where the VPLMN uses one network slice and the HPLMN uses another network slice and the communication for a UE traverses both of these interconnected network slices. The mapped network slice for the HPLMN is the network slice in the HPLMN traversed for the UE communication that is interconnected to the network slice in the VPLMN traversed for the UE communication. The HPLMN and the VPLMN may used their own S-NSSAIs for these two interconnected network slices, where the S-NSSAI in the VPLMN is mapped to the respective S-NSSAI in the HPLMN.

It should be noted that while the description herein focuses on PLMNs, the embodiments described herein are equally applicable to Standalone Non-Public Networks (SNPNs) or Non-Public Networks (NPNs). In this regard, a “roamer” is UE using a subscription of another network than the UE's current network. Thus, the subscribed network can be understood as the HPLMN, and the currently serving or visited network can be understood as the VPLMN.

Certain embodiments may provide one or more of the following technical advantage(s). Embodiments of the present disclosure provide flexible support for NSAC.

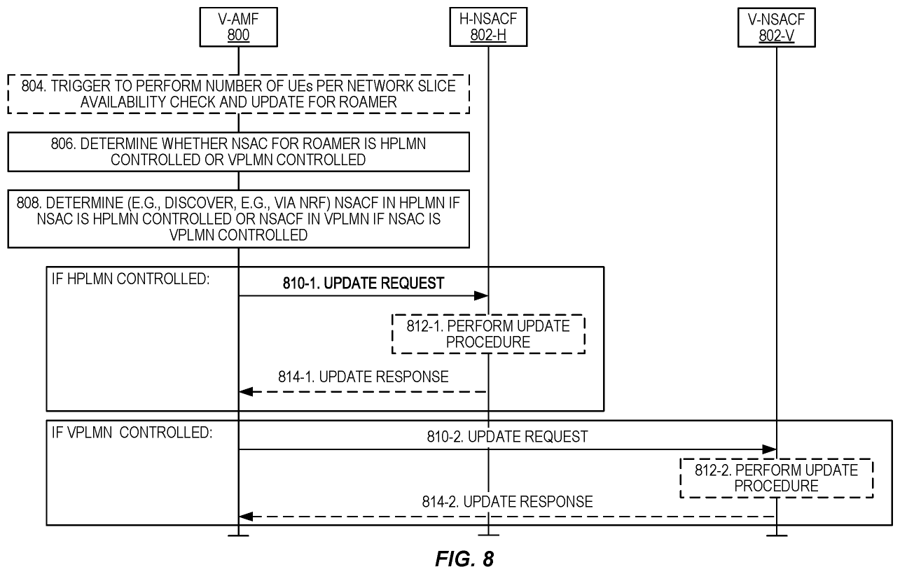

FIG. 8 illustrates the operation of an AMF in a VPLMN, which is denoted herein as V-AMF 800, and either a NSACF in a HPLMN, which is denoted herein as a H-NSACF 802-H, or a NSACF in the VPLMN, which is denoted herein as a V-NSACF 802-V, in accordance with an embodiment of the present disclosure. Note that optional steps are represented by dashed lines. In this embodiment, NSAC for the number of registered UEs for roamers can be HPLMN controlled or VPLMN controlled. For HPLMN control, the NSACF used is located in the HPLMN, i.e., is the H-NSACF 802-H. For VPLMN control, the NSACF used is located in the VPLMN, i.e., is the V-NSACF 802-V.

As illustrated, the V-AMF 800 determines that a trigger has occurred for performing a number of UEs per network slice availability and update check for a roamer (step 804). This roamer is an “outbound roamer” from the perspective of the HPLMN and an “inbound roamer” from the perspective of the VPLMN. Responsive to the trigger, the V-AMF 800 determines whether NSAC for the roamer is HPLMN controlled or VPLMN controlled (step 806). In one embodiment, whether NSAC is HPLMN controlled or VPLMN controlled is configured in the V-AMF 800 performing NSAC. The V-AMF 800 determines (e.g., discovers via an NRF) an NSACF to use for NSAC (step 808). If NSAC is HPLMN controlled, the determined NSACF is the H-NSACF 802-H. If NSAC is VPLMN controlled, the determined NSACF is the V-NSACF 802-V.

If NSAC is HPLMN controlled, the V-AMF 800 sends an update request to the H-NSACF 802-H (step 810-1). In one embodiment, the update request is an Nnsacf_NSAC_NumOfUEsUpdate_Request. In one embodiment, the update request comprises information that indicates a respective network slice for which update is requested, where this information includes, e.g., a S-NSSAI of the network slice in the VPLMN and/or a corresponding mapped S-NSSAI for the network slice in the HPLMN. In one embodiment, the update request also includes a VPLMN Identifier (ID) of the VPLMN. The H-NSACF 802-H performs an update procedure (i.e., NSAC) for the number of registered UEs for the network slice (e.g., for the HPLMN mapped S-NSSAI subject to NSAC) (step 812-1) and sends an update response to the V-AMF 800 (step 814-1).

Alternatively, if NSAC is VPLMN controlled, the V-AMF 800 sends an update request to the V-NSACF 802-V (step 810-2). In one embodiment, the update request is an Nnsacf_NSAC_NumOfUEsUpdate_Request. In one embodiment, the update request comprises information that indicates a respective network slice for which update is requested, where this information includes, e.g., a S-NSSAI of the network slice in the VPLMN and/or a corresponding mapped S-NSSAI for the network slice in the HPLMN. The V-NSACF 802-V performs an update procedure (i.e., NSAC) for the number of registered UEs for the network slice (e.g., for the mapped HPLMN S-NSSAI subject to NSAC, e.g., based on the service level agreement (SLA) between the VPLMN and the HPLMN) (step 812-2) and sends an update response to the V-AMF 800 (step 814-2).

Note that, while not needed for understanding of the embodiments described herein, for more information about the NSAC procedure, the interested reader is directed to the description in FIG. 4.2.11.2-1 of 3GPP TS 23.502 (e.g., V17.3.0).

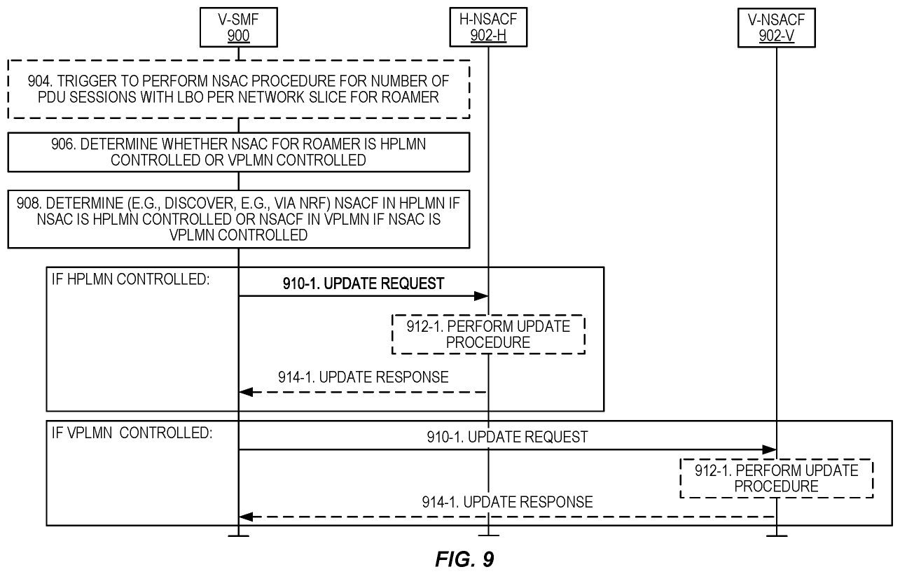

FIG. 9 illustrates the operation of an SMF in a VPLMN, which is denoted herein as V-SMF 900, and either a NSACF in a HPLMN, which is denoted herein as a H-NSACF 902-H, or a NSACF in the VPLMN, which is denoted herein as a V-NSACF 902-V, in accordance with an embodiment of the present disclosure. Note that optional steps are represented by dashed lines. In this embodiment, NSAC for PDU sessions with LBO for roamers can be HPLMN controlled or VPLMN controlled. For HPLMN control, the NSACF used is located in the HPLMN, i.e., is the H-NSACF 902-H. For VPLMN control, the NSACF used is located in the VPLMN, i.e., is the V-NSACF 902-V.

As illustrated, the V-SMF 900 determines that a trigger has occurred for performing an NSAC procedure for PDU sessions with LBO for a roamer (step 904). This roamer is an “outbound roamer” from the perspective of the HPLMN and an “inbound roamer” from the perspective of the VPLMN. Responsive to the trigger, the V-SMF 900 determines whether NSAC for the roamer is HPLMN controlled or VPLMN controlled (step 906). In one embodiment, whether NSAC is HPLMN controlled or VPLMN controlled is configured in the V-SMF 900 performing NSAC. However, Session Management Subscription data on LBO for network slices (e.g., S-NSSAIs) subject to NSAC (e.g., as included in a respective UE's subscription data), when available, takes precedence over any configured information in regard to whether NSAC is HPLMN controlled or VPLMN controlled. The V-SMF 900 determines (e.g., discovers via an NRF) an NSACF to use for NSAC (step 908). If NSAC is HPLMN controlled, the determined NSACF is the H-NSACF 902-H. If NSAC is VPLMN controlled, the determined NSACF is the V-NSACF 902-V.

If NSAC is HPLMN controlled, the V-SMF 900 sends an update request to the H-NSACF 902-H (step 910-1). In one embodiment, the update request is an Nnsacf_NSAC_NumOfPDUsUpdate_Request. In one embodiment, the update request comprises information that indicates a respective network slice for which update is requested, where this information includes, e.g., a S-NSSAI of the network slice in the VPLMN and/or a corresponding mapped S-NSSAI for the network slice in the HPLMN. In one embodiment, the update request also includes a VPLMN ID of the VPLMN. The H-NSACF 902-H performs an update procedure (i.e., NSAC) for the number of PDU sessions with LBO for the network slice (e.g., for the mapped HPLMN S-NSSAI subject to NSAC) (step 912-1) and sends an update response to the V-SMF 900 (step 914-1).

Alternatively, if NSAC is VPLMN controlled, the V-SMF 900 sends an update request to the V-NSACF 902-V (step 910-2). In one embodiment, the update request is an Nnsacf_NSAC_NumOfPDUsUpdate_Request. In one embodiment, the update request comprises information that indicates a respective network slice for which update is requested, where this information includes, e.g., a S-NSSAI of the network slice in the VPLMN and/or a corresponding mapped S-NSSAI for the network slice in the HPLMN. The V-NSACF 902-V may perform an update procedure (i.e., NSAC) for the number of PDU sessions with LBO for the network slice (e.g., for the mapped HPLMN S-NSSAI subject to NSAC, e.g., based on the service level agreement (SLA) between the VPLMN and the HPLMN) (step 912-2) and sends an update response to the V-SMF 900 (step 914-2).

In case of LBO, the subscription information may further include policies to be followed by the VPLMN. These policies are included, e.g., in case of HPLMN control or VPLMN control, and they will generally be different in either case. For example, if the subscription indicates HPLMN control (SLA original with the PLMN is VPLMN Control), the policy may instruct the VPLMN to check with HPLMN only after such a UE established more than a certain number (e.g., 5) LBO sessions to minimize signaling with the HPLMN for every LBO. If the policy is VPLMN (SLA original is HPMLN), it may instruct the VPLMN to use VPLMN control for a specific DNN for this UE, and use HPLMN control for other DNNs. The subscription information or parts of the subscription information (e.g., policies) may be per network slice (e.g., per S-NSSAI) or per DNN.

Note that, while note needed for understanding of the embodiments described herein, for more information about the NSAC procedure for the number of PDU sessions with LBO per network slice, the interested reader is directed to the description in FIG. 4.2.11.4-1 of 3GPP TS 23.502 (e.g., V17.3.0).

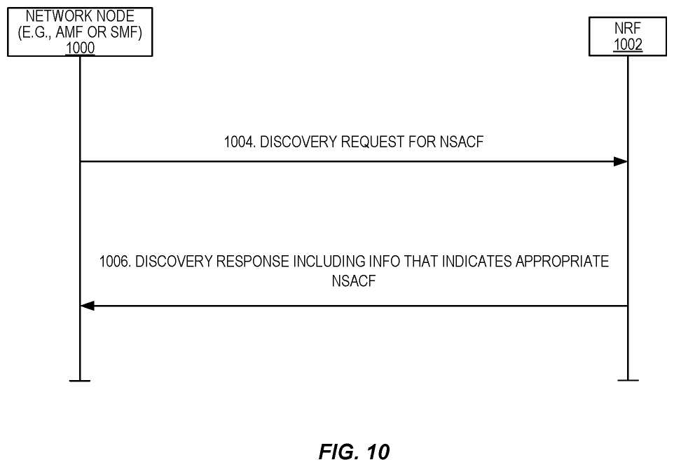

FIG. 10 illustrates a discovery procedure in accordance with one embodiment of the present disclosure. As illustrated, a network node 1000 sends, to a NRF 1002, a discovery request for discovering a NSACF to be used for a NSAC procedure (step 1004). The network node 1000 may be, e.g., the V-AMF 800 or the V-SMF 900. This discovery request may be sent as part of step 808 of FIG. 8 or step 908 of FIG. 9. The NRF 1002 sends a discovery response back to the network node 1000, where the discovery response comprises information about (e.g., that indicates) an appropriate NSACF to be used by the network node 1000 for NSAC (step 1006).

Example implementations of some aspects of some of the embodiments described herein is described below as revised versions of various sections from 3GPP TS 23.501 V17.3.0 and 3GPP TS 23.502 V17.3.0:

### *****Start First Revised Section of 3GPP TS 23.501 V17.3.0*****

### 5.15.11.3 Network Slice Admission Control for Roaming

For network slice admission control of roaming UEs for maximum number of UEs per network slice, the following principles apply:
Depending on operator's policy, a roaming agreement, or an SLA between the VPLMN and the HPLMN, NSAC for roaming UEs may be performed either by the VPLMN or the HPLMN. The NSACF is discovered and selected as per clause 6.3.22.
For HPLMN controlled admission, AMF interacts with a NSACF in the HPLMN dedicated for that purpose.
For VPLMN controlled admission, the AMF interacts with an NSACF in the VPLMN which is configured with the maximum number of allowed roaming UEs per mapped S-NSSAI in the HPLMN for each S-NSSAI in the HPLMN that is subject to NSAC. There is no interaction with the HPLMN in this case.

For network slice admission control of roaming UEs for maximum number of LBO PDU Sessions per network slice the following principles apply:
For the maximum number of PDU Sessions per network slice admission control in LBO roaming case, unless the UE subscription or configuration information in the VPLMN indicates otherwise, the SMF may trigger a request to a NSACF in the VPLMN to perform network slice admission control based on the S-NSSAI in the VPLMN subject to NSAC. The NSACF in the HPLMN is not involved in this case. If the UE profile indicates HPLMN control for LBO sessions, the SMF triggers a request to an NSACF in HPLMN dedicated for that purpose as per clause 6.3.22.
The SMF in the VPLMN provides both the S-NSSAI in the VPLMN and the corresponding mapped S-NSSAI in the HPLMN to the NSACF in the VPLMN.

For network slice admission control for maximum number of HR PDU Sessions per network slice managed by the HPLMN, the following principles shall be used:
For PDU sessions in the home-routed roaming case, the SMF in the HPLMN performs network slice admission control for the S-NSSAI(s) subject to NSAC.

### *****Start Second Revised Section of 3GPP TS 23.501 V17.3.0*****

### 6.3.22 NSACF Discovery and Selection

The NF consumers shall utilise the NRF to discover NSACF instance(s) unless NSACF information is available by other means, e.g. locally configured in NF consumers.

If the NSACF NF consumer is the AMF, the NSACF selection function in the AMF selects an NSACF instance based on the available NSACF instances, which are obtained from the NRF or locally configured in the AMF.

The following factors may be considered by the NF consumer for NSACF selection:
S-NSSAI(s).
NSACF Serving Area information. The NSACF service area is related to the location of the NF consumer.
NOTE: Each Serving Area is unique and unambiguously identified.

A PLMN intending to apply HPLMN control for outbound roamers can have one or more dedicated NSACFs for that purpose. Each NSACF shall have an NSACF service area distinctly, and unambiguously identified for the supported VPLMN(s) for that purpose.
NSACF service capabilities:
   Support monitoring and controlling the number of registered UEs per network slice for the network slice that is subject to NSAC.
   Support monitoring and controlling the number of established PDU Sessions per network slice for the network slice that is subject to NSAC.

In the case of delegated discovery and selection in SCP, the NSACF NF consumer shall send all available factors to the SCP.

### *****Start First Revised Section of 3GPP TS 23.502 V17.3.0*****

### 4.2.11.5.1 NSACF Support for Roaming by VPLMN

Network slice admission control for the number of registered UEs for outbound roamers can be HPLMN controlled or VPLMN controlled. Whether NSAC is HPLMN or VPLMN controlled is configured in AMFs performing NSAC. For HPLMN control, the NSACF used is located in the HPLMN. For VPLMN control, the NSACF used is located in the VPLMN.

Network slice admission control for PDU Sessions with LBO for outbound roamers can be HPLMN controlled or VPLMN controlled. Whether NSAC is HPLMN or VPLMN controlled may be configured in SMFs performing NSAC. However, Session Management Subscription data on LBO for S-NSSAIs subject to NSAC, when available, takes precedence over any configured information.

For NSAC of roaming UEs in case of VPLMN control, a maximum number of allowed UEs per mapped S-NSSAI in HPLMN per mapped S-NSSAI in HPLMN is allocated to the VPLMN for each S-NSSAI in HPLMN and stored in one NSCAF in the VPLMN responsible for NSAC for the S-NSSAI in the HPLMN, subject to NSAC. There is no interaction with the HPLMN in this case.
Editor's note: Whether it is required to interact V-NSACF and H-NSACF for the NSAC of roaming UEs managed by the HPLMN for ‘maximum number of UEs per network slice’ is FFS.

he maximum number of UEs registered with a network slice monitoring and enforcement is done by the NSACF in the VPLMN as per the description in FIG. 4.2.11.2-1 with the following differences:
Step 2, in the Nnsacf_NSAC_NumOfUEsUpdate_Request service operation the AMF provides both the S-NSSAI in VPLMN, and the corresponding mapped S-NSSAI in HPLMN to the NSACF in the VPLMN.
Step 3, the NSACF in the VPLMN performs NSAC for the mapped HPLMN S-NSSAI subject to NSAC based on the SLA between VPLMN and HPLMN.

e For network slice admission control of roaming UEs in case of HPLMN control, AMF uses an NSACF in the HPLMN dedicated for that purpose as per TS 23.501 [2], clause 6.3.22. In this case, network slice monitoring and enforcement is done in the NSACF in the HPLMN as per the description in FIG. 4.2.11.2-1 with the following differences:
Step 2, in the Nnsacf_NSAC_NumOfUEsUpdate_Request service operation the AMF provides the mapped S-NSSAI in HPLMN to the NSACF in the HPLMN, as well as the VPLMN ID.
Step 3, the NSACF in the HPLMN performs NSAC to the HPLMN S-NSSAI subject to NSAC.

For LBO, in case of HPLMN control, SMF uses an NSACF in the HPLMN dedicated for that purpose as per TS 23.501 [2], clause 6.3.22. In this case, network slice monitoring and enforcement is done in the NSACF in the HPLMN as per the description in FIG. 4.2.11.4-1 with the following differences:
Step 2, in the Nnsacf_NSAC_NumOfPDUsUpdate_Request service operation the SMF provides the mapped S-NSSAI in HPLMN to the NSACF in the HPLMN, as well as the VPLMN ID.
Step 3, the NSACF in the HPLMN performs NSAC for the mapped HPLMN S-NSSAI subject to NSAC.

For LBO in case of VPLMN control, enforcement of the maximum number of PDU Sessions established for an S-NSSAI may be performed in the VPLMN by the NSACF in the VPLMN as per the description in FIG. 4.2.11.4-1 with the following differences:
Step 2, in the Nnsacf_NSAC_NumOfPDUsUpdate_Request service operation the SMF provides both the S-NSSAI in VPLMN, and the corresponding mapped S-NSSAI in HPLMN to the NSACF in the VPLMN.
Step 3, the NSACF in the VPLMN performs NSAC for the mapped HPLMN S-NSSAI based on the SLA between VPLMN and HPLMN.

### *****Start Second Revised Section of 3GPP TS 23.502 V17.3.0*****

### 5.2.21.2.2 Nnsacf_NSAC_NumOfUEsUpdate Service Operation

Service Operation name: Nnsacf_NSAC_NumOfUEsUpdate

Description: Updates the number of UEs registered with a network slice (e.g. increase or decrease) when the UE registration status for a network slice subject to NSAC has changed. Also, if the number of the UEs registered with the network slice is to be increased and the Early Availability Check (EAC) mode in the NSACF is activated for that network slice (see Nnsacf_NSAC_EACNotify service operation), the NSACF first checks whether the number of UEs registered with the network slice has reached the maximum number of UEs per network slice threshold. If the maximum number of UEs registered with the network slice has already been reached, the UE registration for that network slice is rejected. If the EAC is not activated, the NSACF increases or decreases the number of UEs per network slice as per the input parameters below.

Inputs, Required: S-NSSAI(s), UE ID (SUPI), NF ID, access type, update flag.

Inputs, Conditional: Notification endpoint for EAC Notification for the S-NSSAI. In support of inbound roamers with HPLMN control, the VPLMN ID is required.

The S-NSSAI(s) parameter is a list of one or more network slices for which the number of UEs registered with a network slice is to be updated and checked if the maximum number of UEs per network slice threshold has already been reached.

The UE ID is used by the NSACF to maintain a list of UE IDs registered with the network slice. The NSACF also takes access type into account for increasing and decreasing the number of UEs per network slice as described in clause 5.15.11.1 of TS 23.501 [2].

The NF ID parameter is the NF instance ID of the NF (e.g. AMF or SMF+PGW-C) sending the request to the NSACF.

The update flag input parameter indicates whether the number of UEs registered with a network slice is to be:
increased when the UE registers to a new network slice subject to NSAC. If the UE ID is already in the list of UEs registered with the network slice, the number of UEs registered with the network slice is not increased as the UE has already been counted as registered with the network slice. If the UE ID is not in the list of UE IDs registered with the network slice and the maximum number of UEs registered with the network slice has not been reached yet, the NSACF adds the UE ID in the list of UEs registered with the network slice and increases the number of the UEs registered with the network slice. If the UE_ID is not in the list of UEs registered with that S-NSSAI and the maximum number of UEs per network slice for that S-NSSAI has already been reached, then the NSACF returns maximum number of UEs per network slice reached result;
decreased when the UE deregisters for a network slice that is subject to NSAC. The NSACF decreases the number of the UEs registered with the network slice and removes the UE ID from the list of UEs registered with the network slice.

To support HPLMN control of inbound roamers, the AMF includes the VPLMN ID.

The NSACF may optionally return the current status of the network slice availability (e.g. a percentage out of the maximum number of UEs registered with a network slice) in the availability status parameter. This information may be used for NSACF signalling and load balancing in case multiple NSACFs are serving the same network slice.
Editor's note: It is FFS how to support in case multi NSACF is supported, e.g. discover the same NSACF, coordination of the local maximum number among NSACF.

Outputs, Required: Result indication.

The Result indication parameter contains the outcome of the update and check operation in the NSACF and may indicate one of the values ‘maximum number of UEs for the S-NSSAI not reached’ or ‘maximum number of UEs for the S-NSSAI reached’.

Outputs, Optional: None.

### *****Start Third Revised Section of 3GPP TS 23.502 V17.3.0*****

### 5.2.21.2.4 Nnsacf_NSAC_NumOfPDUsUpdate Service Operation

Service Operation name: Nnsacf_NSAC_NumOfPDUsUpdate

Description: Updates the number of PDU Sessions established on a network slice (e.g. increase or decrease). Also, if the number of PDU Sessions on the network slice is to be increased, the NSACF first checks whether the number of the PDU Sessions on that network slice has reached the maximum number of PDU Sessions per network slice. If the maximum number of PDU Sessions on the network slice has already been reached, the PDU Session Establishment procedure is rejected.

Inputs, Required: S-NSSAI, UE ID, PDU Session ID, Access Type, update flag.

Inputs, Conditional: In support of inbound roamers with HPLMN control, the VPLMN ID is required.

The S-NSSAI parameter is the network slice for which the number of PDU Sessions established on a network slice is to be updated.

The UE ID parameter is used by the NSACF to maintain a list of UE IDs that has established PDU sessions with the network slice.

PDU Session ID parameter is used by the NSACF to maintain for each UE ID, the PDU Session ID(s) for established PDU Sessions.

The Access Type parameter indicates over which access network type the PDU Session is established. In the case of MA PDU Session, one or multiple Access Types may be included for a PDU Session ID.

The update flag input parameter indicates ‘increase’, ‘decrease’ or ‘update’ as specified in clause 4.2.11.4.

To support HPLMN control of inbound roamers, the SMF includes the VPLMN ID.

Inputs, Optional: None.

Outputs, Required: Result indication, Access Type.

The Result indication parameter contains the outcome of the update and check operation in the NSACF and may indicate one of the values ‘maximum number of PDU Sessions for the S-NSSAI not reached’ or ‘maximum number of PDU Sessions for the S-NSSAI reached’.

The Access Type parameter is associated with the Result indication parameter.

Outputs, Optional: None.

### *****Start Fourth Revised Section of 3GPP TS 23.502 V17.3.0*****

### 5.2.3.3.1 General

Subscription data types used in the Nudm_SubscriberDataManagement Service are defined in Table 5.2.3.3.1-1 below.

TABLE 5.2.3.3.1-1
UE Subscription data types

| Subscription data | | |
|---|---|---|
| type | Field | Description |
| Access and Mobility | GPSI List | List of the GPSI (Generic Public Subscription |
| Subscription data | | Identifier) used both inside and outside of the |
| (data needed for UE | | 3GPP system to address a 3GPP subscription |
| Registration and | | (see NOTE 9). |
| Mobility | Internal Group ID-list | List of the subscribed internal group(s) that the |
| Management) | | UE belongs to. |
| | Subscribed UE-AMBR | The maximum aggregated uplink and downlink |
| | | MBRs to be shared across all Non-GBR QoS |
| | | Flows according to the subscription of the user. |
| | Subscribed UE-Slice-MBR(s) | List of maximum aggregated uplink and downlink |
| | | MBRs to be shared across all GBR and Non-GBR |
| | | QoS Flows related to the same S-NSSAI |
| | | according to the subscription of the user. There is |
| | | a single uplink and a single downlink value per S- |
| | | NSSAI. |
| | Subscribed S-NSSAIs | The Network Slices that the UE subscribes to. In |
| | | the roaming case, it indicates the subscribed |
| | | Network Slices applicable to the Serving PLMN |
| | | (NOTE 11). F |
| | Default S-NSSAIs | The Subscribed S-NSSAIs marked as default S- |
| | | NSSAI. In the roaming case, only those applicable |
| | | to the Serving PLMN (NOTE 12). |
| | S-NSSAIs subject to Network | The Subscribed S-NSSAIs marked as subject to |
| | Slice-Specific Authentication | NSSAA. When present, the GPSI list shall include |
| | and Authorization | at least one GPSI. |
| | Network Slice Simultaneous | Optionally, for each S-NSSAI in the Subscribed S- |
| | Registration Group Information | NSSAIs, one or more value of Network Slice |
| | | Simultaneous Registration Group(s) (NOTE 11) |
| | | associated with the S-NSSAI. |
| | UE Usage Type | As defined in clause 5.15.7.2 of TS 23.501 [2]. |
| | RAT restriction | 3GPP Radio Access Technology(ies) not allowed |
| | | the UE to access. |
| | Forbidden area | Defines areas in which the UE is not permitted to |
| | | initiate any communication with the network. |
| | Service Area Restriction | Indicates Allowed Areas in which the UE is |
| | | permitted to initiate communication with the |
| | | network, and Non-allowed areas in which the UE |
| | | and the network are not allowed to initiate Service |
| | | Request or SM signalling to obtain user services. |
| | Core Network type restriction | Defines whether UE is allowed to connect to 5GC |
| | | and/or EPC for this PLMN. |
| | CAG information | The CAG information includes Allowed CAG list |
| | | and, optionally an indication whether the UE is |
| | | only allowed to access 5GS via CAG cells as |
| | | defined in clause 5.30.3 of TS 23.501 [2]. |
| | CAG information Subscription | When present, indicates to the serving AMF that |
| | Change Indication | the CAG information in the subscription data |
| | | changed and the UE must be updated. |
| | RFSP Index | An index to specific RRM configuration in the NG- |
| | | RAN. |
| | Subscribed Periodic | Indicates a subscribed Periodic Registration |
| | Registration Timer | Timer value, which may be influenced by e.g. |
| | | network configuration parameter as specified in |
| | | clause 4.15.6.3a. |
| | Subscribed Active Time | Indicates a subscribed active time value, which |
| | | may be influenced by e.g. network configuration |
| | | parameter as specified in clause 4.15.6.3a. |
| | MPS priority | Indicates the user is subscribed to MPS as |
| | | indicated in clause 5.16.5 of TS 23.501 [2]. |
| | MCX priority | Indicates the user is subscribed to MCX as |
| | | indicated in clause 5.16.6 of TS 23.501 [2]. |
| | AMF-Associated Expected UE | Information on expected UE movement and |
| | Behaviour parameters | communication characteristics. See |
| | | clause 4.15.6.3 |
| | Steering of Roaming | List of preferred PLMN/access technology |
| | | combinations and/or Credentials Holder controlled |
| | | prioritized lists of preferred SNPNs and GINs or |
| | | HPLMN/Credentials Holder indication that no |
| | | change of the above list(s) stored in the UE is |
| | | needed (see NOTE 3). |
| | | Optionally includes an indication that the UDM |
| | | requests an acknowledgement of the reception of |
| | | this information from the UE. |
| | SoR Update Indicator for Initial | An indication whether the UDM requests the AMF |
| | Registration | to retrieve SoR information when the UE performs |
| | | Registration with NAS Registration Type “Initial |
| | | Registration”. |
| | SoR Update Indicator for | An indication whether the UDM requests the AMF |
| | Emergency Registration | to retrieve SoR information when the UE performs |
| | | Registration with NAS Registration Type |
| | | “Emergency Registration”. |
| | Network Slicing Subscription | When present, indicates to the serving AMF that |
| | Change Indicator | the subscription data for network slicing changed |
| | | and the UE configuration must be updated. |
| | Provide the UE with the full set | Indicates the AMF to provide the UE with the full |
| | of subscribed S-NSSAIs | set of subscribed S-NSSAIs even if they do not |
| | | share a common NSSRG. |
| | Tracing Requirements | Trace requirements about a UE (e.g. trace |
| | | reference, address of the Trace Collection Entity, |
| | | etc.) is defined in TS 32.421 [39]. |
| | | This information is only sent to AMF in the |
| | | HPLMN or one of its equivalent PLMN(s). |
| | Inclusion of NSSAI in RRC | When present, it is used to indicate that the UE is |
| | Connection Establishment | allowed to include NSSAI in the RRC connection |
| | Allowed | Establishment in clear text for 3GPP access. |
| | Service Gap Time | Used to set the Service Gap timer for Service Gap |
| | | Control (see clause 5.31.16 of TS 23.501 [2]). |
| | Subscribed DNN list | List of the subscribed DNNs for the UE (NOTE 1). |
| | | Used to determine the list of LADN available to |
| | | the UE as defined in clause 5.6.5 of |
| | | TS 23.501 [2]. |
| | UDM Update Data | Includes a set of parameters see clause 4.20.1 for |
| | | parameters possible to deliver) to be delivered |
| | | from UDM to the UE via NAS signalling as defined |
| | | in clause 4.20 (NOTE 3). |
| | | Optionally includes an indication that the UDM |
| | | requests an acknowledgement of the reception of |
| | | this information from the UE and an indication for |
| | | the UE to re-register. |
| | NB-IoT UE priority | Numerical value used by the NG-RAN to prioritise |
| | | between UEs accessing via NB-IoT. |
| | Enhanced Coverage Restriction | Specifies whether CE mode B is restricted for the |
| | | UE, or both CE mode A and CE mode B are |
| | | restricted for the UE, or both CE mode A and CE |
| | | mode B are not restricted for the UE. |
| | NB-IoT Enhanced Coverage | Indicates whether Enhanced Coverage for NB-IoT |
| | Restriction | UEs is restricted or not. |
| | IAB-Operation allowed | Indicates that the subscriber is allowed for IAB- |
| | | operation as specified in clause 5.35.2 of |
| | | TS 23.501 [2]. |
| | Charging Characteristics | It contains the Charging Characteristics as |
| | | defined in Annex A of TS 32.256 [71]. |
| | | This information, when provided, shall override |
| | | any corresponding predefined information at the |
| | | AMF. |
| | Extended idle mode DRX cycle | Indicates a subscribed extended idle mode DRX |
| | length | cycle length value. |
| | PCF Selection Assistance info | list of combination of DNN and S-NSSAI that |
| | | indicates that the same PCF needs to be selected |
| | | for AM Policy Control and SM Policy Control |
| | | (NOTE 10). |
| | AerialUESubscriptionInfo | Aerial UE Subscription Information. It contains an |
| | | Indication on whether Aerial service for the UE is |
| | | allowed or not. |
| Slice Selection | Subscribed S-NSSAIs | The Network Slices that the UE subscribes to. In |
| Subscription data | | roaming case, it indicates the subscribed network |
| (data needed for | | slices applicable to the serving PLMN (NOTE 11). |
| Slice Selection as | Default S-NSSAIs | The Subscribed S-NSSAIs marked as default S- |
| described in | | NSSAI. In the roaming case, only those applicable |
| clause 4.2.2.2.3 and | | to the Serving PLMN (NOTE 12). |
| in clause 4.11.0a.5) | S-NSSAIs subject to Network | The Subscribed S-NSSAIs marked as subject to |
| | Slice-Specific Authentication | NSSAA. |
| | and Authorization | |
| | Network Slice Simultaneous | Optionally, for each S-NSSAI in the Subscribed S- |
| | Registration Group (NSSRG) | NSSAIs, the one or more value of Network Slice |
| | Information | Simultaneous Registration Group(s) (NOTE 11) |
| | | associated with the S-NSSAI. |
| SMF Selection | SUPI | Key |
| Subscription data | SMF Selection Subscription data contains one or | |
| (data needed for SMF | more S-NSSAI level subscription data: | |
| Selection as | S-NSSAI | Indicates the value of the S-NSSAI. |
| described | Subscribed DNN list | List of the subscribed DNNs for the UE (NOTE 1). |
| in clause 6.3.2 of | Default DNN | The default DNN if the UE does not provide a |
| TS 23.501 [2]) | | DNN (NOTE 2). |
| | DNN(s) subject to aerial | List of DNNs that are used for aerial services (e.g. |
| | services | UAS operations or C2, etc.) as described in |
| | | TS 23.256 [80]. (see NOTE 13). |
| | LBO Roaming Information | Indicates whether LBO roaming is allowed per |
| | | DNN, or per (S-NSSAI, subscribed DNN). |
| | Interworking with EPS indication | Indicates whether EPS interworking is supported |
| | list | per (S-NSSAI, subscribed DNN). |
| | Same SMF for Multiple PDU | Indication whether the same SMF for multiple |
| | Sessions to the same DNN and | PDU Sessions to the same DNN and S-NSSAI is |
| | S-NSSAI | required. |
| | Invoke NEF indication | When present, indicates, per S-NSSAI and per |
| | | DNN, that NEF based infrequent small data |
| | | transfer shall be used for the PDU Session (see |
| | | NOTE 8). |
| | SMF information for static IP | When static IP address/prefix is used, this may be |
| | address/prefix | used to indicate the associated SMF information |
| | | per (S-NSSAI, DNN). |
| UE context in SMF | SUPI | Key. |
| data | PDU Session Id(s) | List of PDU Session Id(s) for the UE. |
| | For emergency PDU Session Id: | |
| | Emergency Information | The SMF + PGW-C FQDN for emergency session |
| | | used for interworking with EPC. |
| | For each non-emergency PDU Session Id: | |
| | DNN | DNN for the PDU Session. |
| | SMF | Allocated SMF for the PDU Session. Includes |
| | | SMF IP Address and SMF NF Id. |
| | SMF + PGW-C FQDN | The S5/S8 SMF + PGW-C FQDN used for |
| | | interworking with EPS (see NOTE 5). |
| | PCF ID | The PCF ID serving the PDU Session/PDN |
| | | Connection. |
| SMS Management | SMS parameters | Indicates SMS parameters subscribed for SMS |
| Subscription data | | service such as SMS teleservice, SMS barring list |
| (data needed by | Trace Requirements | Trace requirements about a UE (e.g. trace |
| SMSF for SMSF | | reference, address of the Trace Collection Entity, |
| Registration) | | etc.) is defined in TS 32.421 [39]. |
| | | This information is only sent to a SMSF in |
| | | HPLMN. |
| SMS Subscription data | SMS Subscription | Indicates subscription to any SMS delivery service |
| (data needed in AMF) | | over NAS irrespective of access type. |
| UE Context in SMSF | SMSF Information | Indicates SMSF allocated for the UE, including |
| data | | SMSF address and SMSF NF ID. |
| | Access Type | 3GPP or non-3GPP access through this SMSF |
| Session Management | GPSI List | List of the GPSI (Generic Public Subscription |
| Subscription data | | Identifier) used both inside and outside of the |
| (data needed for PDU | | 3GPP system to address a 3GPP subscription. |
| Session | Internal Group ID-list | List of the subscribed internal group(s) that the |
| Establishment) | | UE belongs to. |
| | Trace Requirements | Trace requirements about a UE (e.g. trace |
| | | reference, address of the Trace Collection Entity, |
| | | etc . . .) is defined in TS 32.421 [39]. |
| | | This information is only sent to a SMF in the |
| | | HPLMN or one of its equivalent PLMN(s). |
| | Session Management Subscription data contains one or more | |
| | S-NSSAI level subscription data: | |
| | S-NSSAI | Indicates the value of the S-NSSAI. For each S- |
| | | NSSAI subject to NSAC an indication if LBO for |
| | | outbound roamers is HPLMN controlled or |
| | | VPLMN controlled if the S-NSSAI is subject to |
| | | NSAC. |
| | Subscribed DNN list | List of the subscribed DNNs for the S-NSSAI |
| | | (NOTE 1). |
| | For each DNN in S-NSSAI level subscription data: | |
| | DNN | DNN for the PDU Session. |
| | Aerial service indication | Indicates whether the DNN is used for aerial |
| | | services (e.g. UAS operations or C2, etc.) as |
| | | described in TS 23.256 [80]. |
| | Framed Route information | Set of Framed Routes. A Framed Route refers to |
| | | a range of IPv4 addresses/IPv6 Prefixes to |
| | | associate with a PDU Session established on this |
| | | (DNN, S-NSSAI). See NOTE 4. |
| | IP Index information | Information used for selecting how the UE IP |
| | | address is to be allocated (see clause 5.8.2.2.1 in |
| | | TS 23.501 [2]). |
| | Allowed PDU Session Types | Indicates the allowed PDU Session Types (IPv4, |
| | | IPv6, IPv4v6, Ethernet, and Unstructured) for the |
| | | DNN, S-NSSAI. See NOTE 6. |
| | Default PDU Session Type | Indicates the default PDU Session Type for the |
| | | DNN, S-NSSAI. |
| | Allowed SSC modes | Indicates the allowed SSC modes for the DNN, S- |
| | | NSSAI. |
| | Default SSC mode | Indicate the default SSC mode for the DNN, S- |
| | | NSSAI. |
| | Interworking with EPS indication | Indicates whether interworking with EPS is |
| | | supported for this DNN and S-NSSAI. |
| | 5GS Subscribed QoS profile | The QoS Flow level QoS parameter values (5QI |
| | | and ARP) for the DNN, S-NSSAI (see |
| | | clause 5.7.2.7 of TS 23.501 [2]). |
| | Charging Characteristics | It contains Charging Characteristics as defined in |
| | | Annex A clause A.1 of TS 32.255 [45]. This |
| | | information, when provided, shall override any |
| | | corresponding predefined information at the SMF. |
| | Subscribed-Session-AMBR | The maximum aggregated uplink and downlink |
| | | MBRs to be shared across all Non-GBR QoS |
| | | Flows in each PDU Session, which are |
| | | established for the DNN, S-NSSAI. |
| | Static IP address/prefix | Indicate the static IP address/prefix for the DNN, |
| | | S-NSSAI. |
| | User Plane Security Policy | Indicates the security policy for integrity protection |
| | | and encryption for the user plane. |
| | PDU Session continuity at inter | Provides for this DDN, S-NSSAI how to handle a |
| | RAT mobility | PDU Session when UE the moves to or from NB- |
| | | IoT. Possible values are: maintain the PDU |
| | | session; disconnect the PDU session with a |
| | | reactivation request; disconnect PDU session |
| | | without reactivation request; or to leave it to local |
| | | VPLMN policy. |
| | NEF Identity for NIDD | When present, indicates, per S-NSSAI and per |
| | | DNN, the identity of the NEF to anchor |
| | | Unstructured PDU Session. When not present for |
| | | the S-NSSAI and DNN, the PDU session |
| | | terminates in UPF (see NOTE 8). |
| | NIDD information | Information such as External Group Identifier, |
| | | External Identifier, MSISDN, or AF Identifier used |
| | | for SMF-NEF Connection. |
| | SMF-Associated Expected UE | Parameters on expected characteristics of a PDU |
| | Behaviour parameters | Session their corresponding validity times as |
| | | specified in clause 4.15.6.3. |
| | Suggested number of downlink | Parameters on expected PDU session |
| | packets | characteristics as specified in clauses 4.15.3.2.3b |
| | | and 4.15.6.3a. |
| | ATSSS information | Indicates whether MA PDU session establishment |
| | | is allowed. |
| | Secondary authentication | Indicates that whether the Secondary |
| | indication | authentication/authorization (as defined in |
| | | clause 5.6 of TS 23.501 [2]) is required for PDU |
| | | Session Establishment as specified in |
| | | clause 4.3.2.3. (see NOTE 14) |
| | DN-AAA server UE IP address | Indicates that whether the SMF is required to |
| | allocation indication | request the UE IP address from the DN-AAA |
| | | server (as defined in clause 5.6 of TS 23.501 [2]) |
| | | for PDU Session Establishment as specified in |
| | | clause 4.3.2.3. |
| | DN-AAA server addressing | If at least one of secondary DN-AAA |
| | information | authentication, DN-AAA authorization or DN-AAA |
| | | UE IP address allocation is required by |
| | | subscription data, the subscription data may also |
| | | contain DN-AAA server addressing information. |
| | Edge Configuration Server | Consists of one or more FQDN(s) and/or IP |
| | Address Configuration | Address(es) of Edge Configuration Server(s) as |
| | Information | defined in clause 6.5.2 of TS 23.548 [74]. |
| | API based secondary | Indicates that whether the API based Secondary |
| | authentication indication | authentication/authorization (as defined in |
| | | clause 5.2.3 of TS 23.256 [80]) is required for |
| | | PDU Session Establishment as specified in |
| | | clause 4.3.2.3. (see NOTE 14). |
| | UE authorization for EAS | Indicates whether the UE is authorized to use |
| | discovery via EASDF | 5GC assisted EAS discovery via EASDF (as |
| | | defined in TS 23.548 [74]). |
| Identifier translation | SUPI | Corresponding SUPI for input GPSI. |
| | (Optional) MSISDN | Corresponding GPSI (MSISDN) for input GPSI |
| | | (External Identifier). This is optionally provided for |
| | | legacy SMS infrastructure not supporting |
| | | MSISDN-less SMS. The presence of an MSISDN |
| | | should be interpreted as an indication to the NEF |
| | | that MSISDN shall be used to identify the UE |
| | | when sending the SMS to the SMS-SC via T4. |
| | GPSI | Corresponding GPSI for input SUPI and |
| | | associated application information (e.g. |
| | | Application Port ID) (NOTE 15). |
| Intersystem continuity | (DNN, PGW FQDN) list | For each DNN, indicates the SMF + PGW-C which |
| Context | | support interworking with EPC. |
| LCS privacy | LCS privacy profile data | Provides information for LCS privacy classes and |
| (data needed by | | Location Privacy Indication (LPI) as defined in |
| GMLC) | | clause 5.4.2 in TS 23.273 [51] |
| LCS mobile | LCS Mobile Originated Data | When present, indicates to the serving AMF which |
| origination | | LCS mobile originated services are subscribed as |
| (data needed by AMF) | | defined in clause 7.1 in TS 23.273 [51]. |
| User consent (see | User consent for UE data | Indicates whether the user has given consent for |
| TS 23.288 [50]) | collection | collecting, distributing, and analysing UE related |
| | | data. User consent is provided per purpose (e.g. |
| | | analytics, model training). |
| UE reachability | UE reachability information | Provides, per PLMN, the list of NF IDs or the list |
| | | of NF sets or the list of NF types authorized to |
| | | request notification for UE's reachability |
| | | (NOTE 7). |
| V2X Subscription | NR V2X Services Authorization | Indicates whether the UE is authorized to use the |
| data (see | | NR sidelink for V2X services as Vehicle UE, |
| TS 23.287 [73]) | | Pedestrian UE, or both. |
| | LTE V2X Services Authorization | Indicates whether the UE is authorized to use the |
| | | LTE sidelink for V2X services as Vehicle UE, |
| | | Pedestrian UE, or both. |
| | NR UE-PC5-AMBR | AMBR of UE's NR sidelink (i.e. PC5) |
| | | communication for V2X services. |
| | LTE UE-PC5-AMBR | AMBR of UE's LTE sidelink (i.e. PC5) |
| | | communication for V2X services. |
| ProSe Subscription | ProSe Service Authorization | Indicates whether the UE is authorized to use |
| data (see | | ProSe Direct Discovery, ProSe Direct |
| TS 23.304 [77]) | | Communication, or both and whether the UE is |
| | | authorized to use or serve as a ProSe UE-to- |
| | | Network Relay. |
| | ProSe NR UE-PC5-AMBR | AMBR of UE's NR sidelink (i.e. PC5) |
| | | communication for ProSe services. |
| MBS Subscription | MBS Service Authorization | Indicates whether the UE is authorized to use |
| data (see | | Multicast MBS service. May also indicate the |
| TS 23.247 [78]) | | multicast MBS Session which the UE is allowed to |
| | | join if the UE is authorized to use multicast MBS |
| | | Service. |

NOTE 1:
The Subscribed DNN list can include a wildcard DNN.
NOTE 2:
The default DNN shall not be a wildcard DNN.
NOTE 3:
The Steering of Roaming information and UDM Update Data are protected using the mechanisms defined in TS 33.501 .
NOTE 4:
Framed Route information and Framed Route(s) are defined in TS 23.501 [2].
NOTE 5:
Depending on the scenario PGW-C FQDN may be for S5/S8, or for S2b (ePDG case).
NOTE 6:
The Allowed PDU Session Types configured for a DNN which supports interworking with EPC should contain only the PDU Session Type corresponding to the PDN Type configured in the APN that corresponds to the DNN.
NOTE 7:
Providing a list of NF types or a list of NF sets may be more appropriate for some deployments, e.g. in highly dynamic NF lifecycle management deployments.
NOTE 8:
For a S-NSSAI and a DNN, the “Invoke NEF Indication” shall be present in the SMF selection subscription data if and only if the “NEF Identity for NIDD” Session Management Subscription Data includes a NEF Identity. When the “NEF Identity for NIDD” Session Management Subscription Data includes a NEF Identity for a S-NSSAI and DNN, the “Control Plane Only Indicator” will always be set for PDU Sessions to this S-NSSAI and DNN (see clause 5.31.4.1 of TS 23.501 ).
NOTE 9:
When multiple GPSIs are included in the GPSI list, any GPSI in the list can be used in NSSAA procedures.
NOTE 10:
The same PCF can be selected to serve the UE and to serve one or multiple PDU sessions, each of them is indicated in the list of S-NSSAI, DNN combinations in the PCF Selection Assistance Info. Providing one combination of DNN and S-NSSAI in the PCF Selection Assistance Info is assumed if interworking with EPS is needed. In case multiple PDU sessions to one DNN, S-NSSAI are established in EPS, it is appropriate to select same PCF by configuration or by using existing method, e.g. same PCF selection in usage monitoring.
NOTE 11:
If Network Slice Simultaneous Registration Group information is present, and the VPLMN does not support the subscription-based restrictions to simultaneous registration of network slices, the subset of the Subscribed S-NSSAIs defined in clause 5.15.12 of TS 23.501 [2], are included, without providing the NSSRG information.
NOTE 12:
The Default S-NSSAIs (if more than one is present) are associated with common NSSRG values if NSSRG information is present. At least one Default S-NSSAI shall be present in a subscription including NSSRG information.
NOTE 13:
When UUAA is performed in the AMF (as in clause 5.2.2 of TS 23.256 ) and UUAA-MM status is FAILED or PENDING, the AMF shall reject PDU session establishment requests from the UE for a DNN that is subject to aerial services.
NOTE 14:
For a DNN in S-NSSAI either a DN-AAA based secondary authentication, or an API based secondary authentication can be configured. When API based authentication of the PDU session is required, Secondary authentication indication shall not be present.
NOTE 15:
A GPSI may be associated with Application Port ID, MTC Provider Information and/or AF Identifier.

### *****End Changes*****

### 3 Further Description

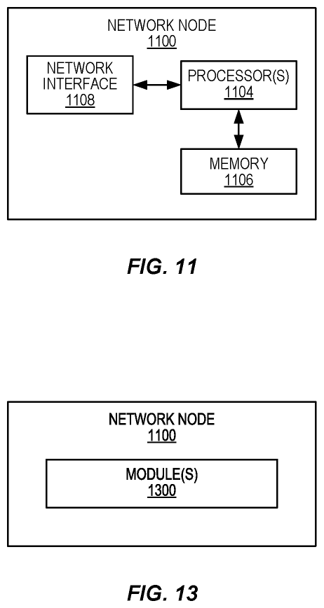

FIG. 11 is a schematic block diagram of a network node 1100 according to some embodiments of the present disclosure. Optional features are represented by dashed boxes. The network node 1100 may be, for example, a core network node that implements a NF (e.g., AMF 200, SMF 206, NSACF 400, NSACF 500, NSACF 600, NSACF 700, UDM/HSS 402, UDM/HSS 502, UDM/HSS 604, or UDR 702, or the like). As illustrated, the network node 1100 includes a one or more processors 1104 (e.g., Central Processing Units (CPUs), Application Specific Integrated Circuits (ASICs), Field Programmable Gate Arrays (FPGAs), and/or the like), memory 1106, and a network interface 1108. The one or more processors 1104 are also referred to herein as processing circuitry. The one or more processors 1104 operate to provide one or more functions of the network node 1100 as described herein (e.g., one or more functions of the AMF 200, SMF 206, NSACF 400, NSACF 500, NSACF 600, NSACF 700, UDM/HSS 402, UDM/HSS 502, UDM/HSS 604, or UDR 702, or the like, as described herein). In some embodiments, the function(s) are implemented in software that is stored, e.g., in the memory 1106 and executed by the one or more processors 1104.

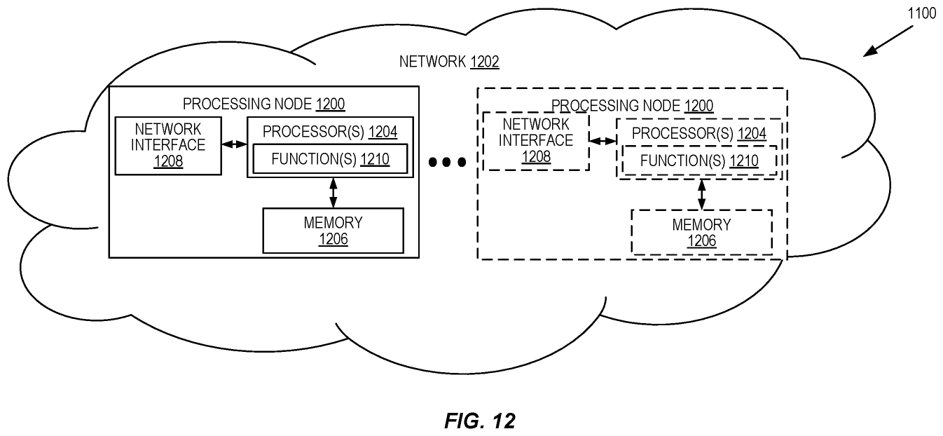

FIG. 12 is a schematic block diagram that illustrates a virtualized embodiment of the network node 1100 according to some embodiments of the present disclosure. Again, optional features are represented by dashed boxes. As used herein, a “virtualized” network node is an implementation of the network node 1100 in which at least a portion of the functionality of the network node 1100 is implemented as a virtual component(s) (e.g., via a virtual machine(s) executing on a physical processing node(s) in a network(s)). As illustrated, in this example, the network node 1100 includes one or more processing nodes 1200 coupled to or included as part of a network(s) 1202. Each processing node 1200 includes one or more processors 1204 (e.g., CPUs, ASICs, FPGAs, and/or the like), memory 1206, and a network interface 1208. In this example, functions 1210 of the network node 1100 described herein (e.g., one or more functions of the AMF 200, SMF 206, NSACF 400, NSACF 500, NSACF 600, NSACF 700, UDM/HSS 402, UDM/HSS 502, UDM/HSS 604, or UDR 702, or the like, as described herein) are implemented at the one or more processing nodes 1200 or distributed across the two or more processing nodes 1200 in any desired manner. In some particular embodiments, some or all of the functions 1210 of the network node 1100 described herein are implemented as virtual components executed by one or more virtual machines implemented in a virtual environment(s) hosted by the processing node(s) 1200.

In some embodiments, a computer program including instructions which, when executed by at least one processor, causes the at least one processor to carry out the functionality of the network node 1100 or a node (e.g., a processing node 1200) implementing one or more of the functions 1210 of the network node 1100 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 13 is a schematic block diagram of the network node 1100 according to some other embodiments of the present disclosure. The network node 1100 includes one or more modules 1300, each of which is implemented in software. The module(s) 1300 provide the functionality of the network node 1100 described herein. This discussion is equally applicable to the processing node 1200 of FIG. 12 where the modules 1300 may be implemented at one of the processing nodes 1200 or distributed across multiple processing nodes 1200.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Those skilled in the art will recognize improvements and modifications to the embodiments of the present disclosure. All such improvements and modifications are considered within the scope of the concepts disclosed herein.

Some example embodiments of the present disclosure are as follows:

Embodiment 1: A method comprising one or more of the following:
at a network node (200; 206) in a Visited Public Land Mobile Network, VPLMN, of a User Equipment, UE, (112):
   receiving (FIG. 4a, step 1; FIG. 6a, step 1), from the UE (112) a request comprising information that indicates a particular network slice that is subject to Network Slice Admission Control, NSAC;
   obtaining (FIG. 4a, step 2; FIG. 6a, step 1b) subscription data that comprises information that indicates a maximum number of registered UEs or PDU sessions for a Home Public Land Mobile Network, HPLMN, mapped network slice associated to the particular network slice indicated by the request received by the network node in the VPLMN;
   sending (FIG. 4a, step 3; FIG. 6a, step 3) an update request to a Network Slice Admission Control Function, NSACF, (400; 600), wherein:
      the update request is a request to update a number of registered UEs or a number of PDU sessions for the HPLMN mapped network slice; and
      the update request comprises information that indicates the maximum number of registered UEs or PDU sessions for the HPLMN mapped network slice;
at the NSACF (400; 600):
   receiving (FIG. 4a, step 3; FIG. 6a, step 3) the update request from the network node (200; 206); and
   storing (FIG. 4a, step 4; FIG. 6a, step 4) the information that indicates the maximum number of registered UEs or PDU sessions for the HPLMN mapped network slice; and
   applying (FIG. 4a, step 4; FIG. 6a, step 4) the maximum number of registered UEs or PDU sessions for the HPLMN mapped network slice to process the update request.

Embodiment 2: The method of embodiment 1 wherein the network node (200) is an AMF (200), and the information that indicates the maximum number of registered UEs or PDU sessions for the HPLMN mapped network slice is information that indicates the maximum number of registered UEs for the HPLMN mapped network slice.

Embodiment 3: The method of embodiment 1 wherein the network node (200) is an SMF (206), and the information that indicates the maximum number of registered UEs or PDU sessions for the HPLMN mapped network slice is information that indicates the maximum number of PDU sessions for the HPLMN mapped network slice.

Embodiment 4: The method of any of embodiments 1 to 3 further comprising one or more of the following:
at a UDM or UDR (402; 602):
   receiving (FIG. 4b, step 7; FIG. 6b, step 7) an updated, or changed, maximum number of registered UEs or PDU sessions for the HPLMN mapped network slice;
   notifying (FIG. 4b, step 8 or 9; FIG. 6b, step 8) a second network node (200; 206), which may or may not be the same as the network node (200; 206), of the updated maximum number of registered UEs or PDU sessions for the HPLMN mapped network slice;
at the second network node (200; 206):
   receiving (FIG. 4b, step 8 or 9; FIG. 6b, step 8) the notification from the UDM or UDR (402; 602);
   sending (FIG. 4b, step 10; FIG. 6b, step 10), to the NSACF (400; 600), a second update request comprising information that indicates the updated maximum number of registered UEs or PDU sessions for the HPLMN mapped network slice;
at the NSACF (400; 600):
   receiving (FIG. 4b, step 10; FIG. 6b, step 10) the second update request; and
   storing (FIG. 4b, step 11; FIG. 6b, step 11) the updated maximum number of registered UEs or PDU sessions for the HPLMN mapped network slice for subsequent application by the NSACF (400; 600).

Embodiment 5: A method performed by a network node (200; 206) in a Visited Public Land Mobile Network, VPLMN, of a User Equipment, UE, (112), the method comprising one or more of the following:
receiving (FIG. 4a, step 1; FIG. 6a, step 1), from the UE (112), a request comprising information that indicates a particular network slice that is subject to Network Slice Admission Control, NSAC;
obtaining (FIG. 4a, step 2; FIG. 6a, step 1b) subscription data that comprises information that indicates a maximum number of registered UEs or PDU sessions for a Home Public Land Mobile Network, HPLMN, mapped network slice associated to the particular network slice indicated by the request received by the network node in the VPLMN;
sending (FIG. 4a, step 3; FIG. 6a, step 3) an update request to a Network Slice Admission Control Function, NSACF, (400; 600), wherein:
   the update request a request to update a number of registered UEs or a number of PDU sessions for the HPLMN mapped network slice; and
   the update request comprises information that indicates the maximum number of registered UEs or PDU sessions for the HPLMN mapped network slice.

Embodiment 6: The method of embodiment 5 wherein the network node (200) is an AMF (200), and the information that indicates the maximum number of registered UEs or PDU sessions for the HPLMN mapped network slice is information that indicates the maximum number of registered UEs for the HPLMN mapped network slice.

Embodiment 7: The method of embodiment 5 wherein the network node (200) is an SMF (206), and the information that indicates the maximum number of registered UEs or PDU sessions for the HPLMN mapped network slice is information that indicates the maximum number of PDU sessions for the HPLMN mapped network slice.

Embodiment 8: The method of any of embodiments 5 to 7 further comprising one or more of the following:
receiving (FIG. 4b, step 8 or 9; FIG. 6b, step 8), from a UDM or UDR (402; 602), a notification of an updated maximum number of registered UEs or PDU sessions for the HPLMN mapped network slice;
sending (FIG. 4b, step 10; FIG. 6b, step 10), to the NSACF (400; 600), a second update request comprising information that indicates the updated maximum number of registered UEs or PDU sessions for the HPLMN mapped network slice.

Embodiment 9: A method performed by a Network Slice Admission Control Function, NSACF, (400; 600), the method comprising one or more of the following:
receiving (FIG. 4a, step 3; FIG. 6a, step 3) an update request from a network node (200; 206), wherein:
   the update request is a request to update a number of registered UEs or a number of PDU sessions for a HPLMN mapped network slice; and
   the update request comprises information that indicates the maximum number of registered UEs or PDU sessions for the HPLMN mapped network slice;
storing (FIG. 4a, step 4; FIG. 6a, step 4) the information that indicates the maximum number of registered UEs or PDU sessions for the HPLMN mapped network slice; and
applying (FIG. 4a, step 4; FIG. 6a, step 4) the maximum number of registered UEs or PDU sessions for the HPLMN mapped network slice to process the update request.

Embodiment 10: The method of embodiment 9 wherein the network node (200) is an AMF (200), and the information that indicates the maximum number of registered UEs or PDU sessions for the HPLMN mapped network slice is information that indicates the maximum number of registered UEs for the HPLMN mapped network slice.

Embodiment 11: The method of embodiment 9 wherein the network node (200) is an SMF (206), and the information that indicates the maximum number of registered UEs or PDU sessions for the HPLMN mapped network slice is information that indicates the maximum number of PDU sessions for the HPLMN mapped network slice.

Embodiment 12: The method of any of embodiments 9 to 11 further comprising one or more of the following:
receiving (FIG. 4b, step 10; FIG. 6b, step 10) a second update request from a second network node (200; 206), which may or may not be the same as the network node (200; 206), wherein the second update request comprises information that indicates an updated maximum number of registered UEs or PDU sessions for the HPLMN mapped network slice; and
storing (FIG. 4b, step 11; FIG. 6b, step 11) the updated maximum number of registered UEs or PDU sessions for the HPLMN mapped network slice for subsequent application by the NSACF (400; 600).

Embodiment 13: A method performed by a UDM or UDR, the method comprising one or more of the following:
receiving (FIG. 4b, step 7; FIG. 6b, step 7) an updated, or changed, maximum number of registered UEs or PDU sessions for a HPLMN mapped network slice;
notifying (FIG. 4b, step 8 or 9; FIG. 6b, step 8) a network node (200; 206) of the updated maximum number of registered UEs or PDU sessions for the HPLMN mapped network slice.

Embodiment 14: The method of embodiment 13 wherein the network node (200) is an AMF (200), and the updated maximum number of registered UEs or PDU sessions for the HPLMN mapped network slice is an updated maximum number of registered UEs for the HPLMN mapped network slice.

Embodiment 15: The method of embodiment 13 wherein the network node (200) is an SMF (206), and the updated maximum number of registered UEs or PDU sessions for the HPLMN mapped network slice is an updated maximum number of PDU sessions for the HPLMN mapped network slice.

Embodiment 16: A method comprising one or more of the following:
at a network node (200; 206) in a Visited Public Land Mobile Network, VPLMN, of a User Equipment, UE, (112):
   receiving (FIG. 5, step 1), from the UE (112), a request comprising information that indicates a particular network slice (or one or more particular network slices) that is subject to Network Slice Admission Control, NSAC;
   sending (FIG. 5, step 3) an update request to a Network Slice Admission Control Function, NSACF, (500), wherein the update request is a request to update a number of registered UEs or a number of PDU sessions for the HPLMN mapped network slice; and
at the NSACF (500):
   receiving (FIG. 5, step 3) the update request from the network node (200; 206);
   obtaining (FIG. 5, step 4) information that indicates a maximum number of registered UEs or PDU sessions for a HPLMN mapped network slice associated to the particular network slice from a storage node (500); and
   applying (FIG. 5, step 4) the maximum number of registered UEs or PDU sessions for the HPLMN mapped network slice to process the update request.

Embodiment 17: The method of embodiment 16 further comprising:
at the NSACF (500):
   subscribing (FIG. 5, step 6) to changes in slice selection subscription data comprising changes to the maximum number of registered UEs or PDU sessions for the HPLMN mapped network slice;
at the storage node (502):
   responsive to the subscription, notifying (FIG. 5, step 8) the NSACF (500) of a change to the maximum number of registered UEs or PDU sessions for the HPLMN mapped network slice.

Embodiment 18: A method performed by a Network Slice Admission Control Function, NSACF, (500), the method comprising one or more of the following:
receiving (FIG. 5, step 3) an update request from a network node (200; 206) in a Visited Public Land Mobile Network, VPLMN, of a User Equipment, UE, (112), the update request being a request to update a number of registered UEs or a number of PDU sessions for the HPLMN mapped network slice;
obtaining (FIG. 5, step 4) information that indicates a maximum number of registered UEs or PDU sessions for a HPLMN mapped network slice associated to the particular network slice from a storage node (500); and
applying (FIG. 5, step 4) the maximum number of registered UEs or PDU sessions for the HPLMN mapped network slice to process the update request.

Embodiment 19: The method of embodiment 18 further comprising:
subscribing (FIG. 5, step 6) to changes in slice selection subscription data comprising changes to the maximum number of registered UEs or PDU sessions for the HPLMN mapped network slice; and
responsive to the subscribing, receiving (FIG. 5, step 8) a notification of a change to the maximum number of registered UEs or PDU sessions for the HPLMN mapped network slice.

Embodiment 20: A method performed by a UDM or HSS (502), the method comprising one or more of the following:
receiving (FIG. 5, step 6), from a NSACF (500), a subscription to changes in slice selection subscription data comprising changes to a maximum number of registered UEs or PDU sessions for a HPLMN mapped network slice; and
responsive to the subscription, sending (FIG. 5, step 8), to the NSACF (500), a notification of a change to the maximum number of registered UEs or PDU sessions for the HPLMN mapped network slice.

Embodiment 21: A method comprising one or more of the following:
at a NSACF (700):
   receiving (FIG. 7, step 5), from a network node (200; 206), an update request, the update request being a request to update a number of registered UEs or a number of PDU sessions for the HPLMN mapped network slice;
   sending (FIG. 7, step 6) a request to a UDM for a maximum number of registered UEs or PDU session for the HPLMN mapped network slice;
at the UDR (702):
   receiving (FIG. 7, step 6) the request from the NSACF (700);
   sending (FIG. 7, step 6) a response to the NSACF (700), the response comprising information that indicates the maximum number of registered UEs or PDU session for the HPLMN mapped network slice; and
at the NSACF (700):
   receiving (FIG. 7, step 6) the response from the UDM comprising the information that indicates the maximum number of registered UEs or PDU session for the HPLMN mapped network slice; and
   applying (FIG. 7, step 6) the maximum number of registered UEs or PDU session for the HPLMN mapped network slice when processing the update request.

Embodiment 22: A method performed by a NSACF (700), the method comprising one or more of the following:
receiving (FIG. 7, step 5), from a network node (200; 206), an update request, the update request being a request to update a number of registered UEs or a number of PDU sessions for the HPLMN mapped network slice;
obtaining (FIG. 7, step 6), from a UDM (702), information that indicates a maximum number of registered UEs or PDU session for the HPLMN mapped network slice; and
applying (FIG. 7, step 6) the maximum number of registered UEs or PDU session for the HPLMN mapped network slice when processing the update request.

Embodiment 23: A method performed by a UDR (700), the method comprising one or more of the following:
receiving (FIG. 7, step 6) a request from a NSACF (700), the request being a request for a maximum number of registered UEs or PDU session for the HPLMN mapped network slice; and
sending (FIG. 7, step 6) a response to the NSACF (700), the response comprising information that indicates the maximum number of registered UEs or PDU session for the HPLMN mapped network slice.

Embodiment 24: A network node adapted to perform the method of any one of the network nodes of any of embodiments 1 to 23.

Embodiment 25: A method performed by a network node (800; 900) in Visited Public Land Mobile Network, VPLMN, the method comprising one or more of the following: determining (806; 906) whether network slice admission control, NSAC, for a roamer for a particular network slice is Home Public Land Mobile Network, HPLMN, controlled or VPLMN controlled; determining (808; 908) a Network Slice Admission Control Function, NSACF, to use for a NSAC procedure for the roamer for the particular network slice, the NSACF being a NSACF (802-H; 902-H) in the HPLMN if the NSAC for the roamer for the particular network slice is HPLMN controlled and a NSACF (802-V; 902-V) in the VPLMN if the NSAC for the roamer for the particular network slice is VPLMN controlled; and sending (810-1 or 810-2; 910-1 or 910-2) a request related to NSAC for the particular network slice to the determined NSACF.

Embodiment 26: The method of embodiment 25 wherein determining (806; 906) whether NSAC for the roamer for the particular network slice is HPLMN controlled or VPLMN controlled comprises determining (806; 906) whether NSAC for the roamer for the particular network slice is HPLMN controlled or VPLMN controlled based on configured or acquired information.

Embodiment 27: The method of claim 26 wherein the configured or acquired information is acquired information received as part of subscription information (e.g., from a UDM).

Embodiment 28: The method of any of embodiments 25 to 27 wherein the network node (800) is an Access and Mobility Management Function, AMF, (800), and the update request is an update request for a number of registered User Equipments, UEs, for the particular network slice.

Embodiment 29: The method of any of embodiments 25 to 27 wherein the network node (900) is a Session Management Function, SMF, (900), and the update request is an update request for a number of Protocol Data Unit, PDU, sessions with Local Breakout, LBO, for the particular network slice.

Embodiment 30: The method of any of embodiments 25 to 29 wherein the update request comprises information that indicates the particular network slice.

Embodiment 31: The method of any of embodiments 25 to 29 wherein the determined NSACF is a NSACF (802-H; 902-H) in the HPLMN, and the information that indicates the particular network slice comprises a Single Network Slice Assistance Information, S-NSSAI, mapped to the particular network slice in the HPLMN and/or a S-NSSAI of the particular network slice in the VPLMN.

Embodiment 32: The method of embodiment 31 wherein the update request further comprises an identifier of the VPLMN.

Embodiment 33: The method of any of embodiments 25 to 29 wherein the determined NSACF is a NSACF (802-V; 902-V) in the VPLMN, and the information that indicates the particular network slice comprises a Single Network Slice Assistance Information, S-NSSAI, mapped to the particular network slice in the HPLMN and/or a S-NSSAI of the particular network slice in the VPLMN.

Embodiment 34: A network node (800; 900) configured to perform the method of any of embodiments 25 to 33.

Embodiment 35: A method performed by a Network Repository Function, NRF, (1002), the method comprising: receiving (1004), from a network node (1000) in a VPLMN, a discovery request for a NSACF is a HPLMN; and sending (1006), to the network node (1000), information about the NSACF in the HPLMN.

Embodiment 36: A network node (1002) configured to perform the method of embodiment 35.

Those skilled in the art will recognize improvements and modifications to the embodiments of the present disclosure. All such improvements and modifications are considered within the scope of the concepts disclosed herein.

1. A method performed by a network node in a Visited Public Land Mobile Network, VPLMN, of a User Equipment, UE, the method comprising:
receiving, from the UE, a request comprising information indicating a particular network slice that is subject to Network Slice Admission Control, NSAC;
obtaining subscription data that comprises information that indicates whether VPLMN or Home Public Land Mobile Network, HPLMN, control should be applied for NSAC; and
sending an update request to a Network Slice Admission Control Function, NSACF, in the VPLMN of the UE, wherein the update request comprises the information that indicates whether VPLMN or HPLMN control should be applied for NSAC.

2. A network node for a Visited Public Land Mobile Network, VPLMN, of a User Equipment, UE, the network node comprising processing circuitry configured to cause the network node to:
receive, from the UE, a request comprising information indicating a particular network slice that is subject to Network Slice Admission Control, NSAC;
obtain subscription data that comprises information that indicates whether VPLMN or Home Public Land Mobile Network, HPLMN, control should be applied for NSAC; and
send an update request to a Network Slice Admission Control Function, NSACF, in the VPLMN of the UE, wherein the update request comprises the information that indicates whether VPLMN or HPLMN control should be applied for NSAC.

3. A method performed by a Network Slice Admission Control Function, NSACF, in a Visited Public Land Mobile Network, VPLMN, of a User Equipment, UE, the method comprising:
receiving, from a network node in the VPLMN of the UE, an update request, the update request being a request to update a number of registered UEs or a number of Protocol Data Unit, PDU, sessions for a Home Public Land Mobile Network, HPLMN, mapped network slice;
obtaining subscription data indicating whether VPLMN or HPLMN control should be applied for Network Slice Admission Control, NSAC;
obtaining, from the HPLMN, information that indicates a maximum number of registered UEs or PDU session for the HPLMN mapped network slice; and
applying the maximum number of registered UEs or PDU sessions for the HPLMN mapped network slice when processing the update request.

4. The method of claim 3, wherein obtaining the subscription data indicating whether VPLMN or HPLMN control should be applied for NSAC comprises obtaining the subscription data from any one of:
a. the network node in the VPLMN of the UE;
b. a User Data Management in the HPLMN of the UE; or
c. a network node in the HPLMN of the UE.

5. The method of claim 3 further comprising subscribing at the HPLMN to any changes to the information that indicates the maximum number of registered UEs or PDU session for the HPLMN mapped network slice.

6. The method according to claim 3 further comprising, for any subsequent update requests to add a UE entry exceeding the maximum number of registered UEs or PDU sessions for the HPLMN mapped network slice, obtaining admission control from the HPLMN indicating if the request should be granted or not and upon determining the request is granted storing the UE entry.

7. The method according to claim 3 further comprising, for any subsequent update requests to add a UE entry exceeding the maximum number of registered UEs or PDU sessions for the HPLMN mapped network slice, rejecting the update request.

8. A network node that implements a Network Slice Admission Control Function, NSACF, for a Visited Public Land Mobile Network, VPLMN, of a User Equipment, UE, the network node comprising processing circuitry configured to cause the network node to:
receive, from a network node in the VPLMN of the UE, an update request, the update request being a request to update a number of registered UEs or a number of Protocol Data Unit, PDU, sessions for a Home Public Land Mobile Network, HPLMN, mapped network slice;
obtain subscription data indicating whether VPLMN or HPLMN control should be applied for Network Slice Admission Control, NSAC;
obtain, from the HPLMN, information that indicates a maximum number of registered UEs or PDU session for the HPLMN mapped network slice; and
apply the maximum number of registered UEs or PDU sessions for the HPLMN mapped network slice when processing the update request.

9. (canceled)

10. A method comprising:
at a network node in a Visited Public Land Mobile Network, VPLMN, of a User Equipment, UE:
receiving, from the UE, a request comprising information that indicates a particular network slice that is subject to Network Slice Admission Control, NSAC;
sending an update request to a Network Slice Admission Control Function, NSACF, in the VPLMN of the UE, wherein the update request is a request to update a number of registered UEs or a number of PDU sessions for the HPLMN mapped network slice; and
at the NSACF in the VPLMN of the UE:
receiving the update request from the network node;
obtaining information that indicates a maximum number of registered UEs or PDU sessions for a HPLMN mapped network slice associated to the particular network slice from a network node in the HPLMN of the UE; and
applying the maximum number of registered UEs or PDU sessions for the HPLMN mapped network slice to process the update request.

11. The method of claim 10 further comprising, at the network node in the VPLMN of the UE, obtaining subscription data for the UE, the subscription data comprising information that indicates whether Network Slice Admission Control, NSAC, is controlled by the VPLMN or controlled by the HPLMN.

12. The method of claim 10 further comprising:
at the NSACF in the VPLMN of the UE:
subscribing to changes in slice selection subscription data comprising changes to the maximum number of registered UEs or PDU sessions for the HPLMN mapped network slice; and
at the network node in the HPLMN of the UE:
responsive to the subscription, notifying the NSACF in the VPLMN of the UE of a change to the maximum number of registered UEs or PDU sessions for the HPLMN mapped network slice.

13. A method performed by a Network Slice Admission Control Function, NSACF, in a Visited Public Land Mobile Network, VPLMN, of a User Equipment, UE, the method comprising:
receiving an update request from a network node in the VPLMN the UE, the update request being a request to update a number of registered UEs or a number of Protocol Data Unit, PDU, sessions for a particular network slice;
obtaining information that indicates a maximum number of registered UEs or PDU sessions for a HPLMN mapped network slice associated to the particular network slice from a network node in the HPLMN of the UE; and
applying the maximum number of registered UEs or PDU sessions for the HPLMN mapped network slice to process the update request.

14. The method of claim 13 further comprising:
subscribing to changes in slice selection subscription data comprising changes to the maximum number of registered UEs or PDU sessions for the HPLMN mapped network slice; and
responsive to the subscribing, receiving a notification of a change to the maximum number of registered UEs or PDU sessions for the HPLMN mapped network slice.

15. A network node that implements a Network Slice Admission Control Function, NSACF, for a Visited Public Land Mobile Network, VPLMN, of a User Equipment, UE, the network node comprising processing circuitry configured to cause the network node to:
receive an update request from a network node in the VPLMN the UE, the update request being a request to update a number of registered UEs or a number of Protocol Data Unit, PDU, sessions for a particular network slice;
obtain information that indicates a maximum number of registered UEs or PDU sessions for a HPLMN mapped network slice associated to the particular network slice from a network node in the HPLMN of the UE; and
apply the maximum number of registered UEs or PDU sessions for the HPLMN mapped network slice to process the update request.

16-44. (canceled)
